(19) United States
(12) Patent Application Publication
(10) Pub. No.: US 2026/0006679 A1
(43) Pub. Date: Jan. 1, 2026

(54) NESTED DISCONTINUOUS RECEPTION (DRX) CYCLES

(71) Applicant: QUALCOMM Incorporated, San Diego, CA (US)

(72) Inventors: Ahmed ELSHAFIE, San Diego, CA (US); Linhai HE, San Diego, CA (US); Yuchul KIM, San Diego, CA (US); Zhikun WU, Beijing (CN); Huilin XU, Temecula, CA (US); Seyedkianoush HOSSEINI, San Diego, CA (US); Tingfang JI, San Diego, CA (US); Krishna Kiran MUKKAVILLI, San Diego, CA (US); Peter GAAL, San Diego, CA (US); Wanshi CHEN, San Diego, CA (US); Le LIU, San Jose, CA (US)

(21) Appl. No.: 18/992,042

(22) PCT Filed: Aug. 9, 2022
(86) PCT No.: PCT/CN2022/111097

§ 371 Date: Jan. 7, 2025

(51) Int. Cl. H04W 76/28; H04W 52/02

(52) U.S. Cl. CPC H04W 76/28; H04W 52/0216

(57) ABSTRACT

Systems and methods for nested discontinuous reception (DRX) cycles in a wireless communication system are provided. A UE may be a low power device such as an energy harvesting UE. Based on an energy harvesting capability of the UE, the UE may communicate information to a network unit. Based on the information from the UE, the network unit may configure the UE for nested DRX cycles. The nested DRX configuration may include outer DRX cycle timing parameters, and inner DRX cycle timing parameters, such that when the outer DRX cycle is in the “on” duration, the inner DRX cycle alternates between “on” and “off” durations according to the inner DRX cycle timing.

### TECHNICAL FIELD

This application relates to wireless communication devices, systems, and methods, and more particularly to devices, systems, and methods for nested discontinuous reception (DRX) cycles.

### INTRODUCTION

Wireless communications systems are widely deployed to provide various types of communication content such as voice, video, packet data, messaging, broadcast, and so on. These systems may be capable of supporting communication with multiple users by sharing the available system resources (e.g., time, frequency, and power). A wireless multiple-access communications system may include a number of base stations (BSs), each simultaneously supporting communications for multiple communication devices, which may be otherwise known as user equipment (UE).

To meet the growing demands for expanded mobile broadband connectivity, wireless communication technologies are advancing from the long term evolution (LTE) technology to a next generation new radio (NR) technology, which may be referred to as 5^{th} Generation (5G), designed to provide a lower latency, a higher bandwidth or a higher throughput, and a higher reliability than LTE.

In order to conserve energy, devices on some networks schedule communication to occur periodically so that a device may consume less power between bursts of communication. For very low power devices such as energy harvesting devices, existing discontinuous reception (DRX) methods are insufficient as they lack the ability to configure cycles which account for relatively long charging times, and are not easily adaptable to changing conditions. Therefore, there exists a need for improved methods of discontinuous reception.

### BRIEF SUMMARY OF SOME EXAMPLES

The following summarizes some aspects of the present disclosure to provide a basic understanding of the discussed technology. This summary is not an extensive overview of all contemplated features of the disclosure and is intended neither to identify key or critical elements of all aspects of the disclosure nor to delineate the scope of any or all aspects of the disclosure. Its sole purpose is to present some concepts of one or more aspects of the disclosure in summary form as a prelude to the more detailed description that is presented later.

One aspect of the present disclosure includes a method of wireless communication, comprising receiving, by an energy harvesting user equipment (UE) from a network unit, a data requirement. The method further comprises transmitting, by the UE to the network unit, a first parameter related to an energy harvesting capability of the UE. The method further comprises receiving, by the UE from the network unit, a DRX configuration based on the first parameter, the DRX configuration including: an outer DRX cycle duration, an outer DRX cycle on time duration, an inner DRX cycle duration, and an inner DRX cycle on time duration. The method further comprises monitoring for a message from the network unit, based on the DRX configuration, during a plurality of on durations of an inner DRX cycle within an on duration of an outer DRX cycle.

Another aspect of the present disclosure includes a method of wireless communication, comprising transmitting, by a network unit to an energy harvesting user equipment (UE), a data requirement. The method further comprises receiving, by the network unit from the UE, a first parameter related to an energy harvesting capability of the UE. The method further comprises transmitting, by the network unit to the UE, a DRX configuration based on the first parameter, the DRX configuration including: an outer DRX cycle duration, an outer DRX cycle on time duration, an inner DRX cycle duration, and an inner DRX cycle on time duration. The method further comprises transmitting a message from the network unit, based on the DRX configuration, during a plurality of on durations of an inner DRX cycle within an on duration of an outer DRX cycle.

Another aspect of the present disclosure includes an energy harvesting user equipment (UE) comprising a transceiver configured to receive, from a network unit, a data requirement. The transceiver is further configured to transmit, to the network unit, a first parameter related to an energy harvesting capability of the UE. The transceiver is further configured to receive, from the network unit, a DRX configuration based on the first parameter, the DRX configuration including: an outer DRX cycle duration, an outer DRX cycle on time duration, an inner DRX cycle duration, and an inner DRX cycle on time duration. The UE further comprises a processor configured to monitor for a message, from the network unit, based on the DRX configuration, during a plurality of on durations of an inner DRX cycle within an on duration of an outer DRX cycle.

Another aspect of the present disclosure includes a network unit, comprising a transceiver configured to transmit, to an energy harvesting user equipment (UE), a data requirement. The transceiver is further configured to receive, from the UE, a first parameter related to an energy harvesting capability of the UE. The transceiver is further configured to transmit, to the UE, a DRX configuration based on the first parameter, the DRX configuration including: an outer DRX cycle duration, an outer DRX cycle on time duration, an inner DRX cycle duration, and an inner DRX cycle on time duration. The transceiver is further configured to transmit a message, based on the

DRX configuration, during a plurality of on durations of an inner DRX cycle within an on duration of an outer DRX cycle.

Other aspects, features, and embodiments will become apparent to those of ordinary skill in the art, upon reviewing the following description of specific, exemplary aspects in conjunction with the accompanying figures. While features may be discussed relative to certain aspects and figures below, all aspects can include one or more of the advantageous features discussed herein. In other words, while one or more aspects may be discussed as having certain advantageous features, one or more of such features may also be used in accordance with the various aspects discussed herein. In similar fashion, while exemplary aspects may be discussed below as device, system, or method aspects it should be understood that such exemplary aspects can be implemented in various devices, systems, and methods.

### BRIEF DESCRIPTION OF THE DRAWINGS

FIG. 1 illustrates a wireless communication network according to some aspects of the present disclosure.

FIG. 2 illustrates an example portion of a wireless communications system that supports RU sharing techniques in wireless communications according to some aspects of the present disclosure.

FIG. 3 illustrates a diagram of a system including a device that supports RU sharing techniques in wireless communications according to some aspects of the present disclosure.

FIG. 4 illustrates a simplified diagram of an energy charging scheme according to some aspects of the present disclosure.

FIG. 5 illustrates a simplified diagram of a nested DRX scheme according to some aspects of the present disclosure.

FIG. 6 is a signaling diagram according to some aspects of the present disclosure.

FIG. 7 is a signaling diagram according to some aspects of the present disclosure.

FIG. 8 is a signaling diagram according to some aspects of the present disclosure.

FIG. 9 illustrates a block diagram of a network unit according to some aspects of the present disclosure.

FIG. 10 illustrates a block diagram of a user equipment (UE) according to some aspects of the present disclosure.

FIG. 11 is a flow diagram of a wireless communication method performed by a UE according to some aspects of the present disclosure.

FIG. 12 is a flow diagram of a wireless communication method performed by a network unit according to some aspects of the present disclosure.

### DETAILED DESCRIPTION

The detailed description set forth below, in connection with the appended drawings, is intended as a description of various configurations and is not intended to represent the only configurations in which the concepts described herein may be practiced. The detailed description includes specific details for the purpose of providing a thorough understanding of the various concepts. However, it will be apparent to those skilled in the art that these concepts may be practiced without these specific details. In some aspects, well-known structures and components are shown in block diagram form in order to avoid obscuring such concepts.

This disclosure relates generally to wireless communications systems, also referred to as wireless communications networks. In various aspects, the techniques and apparatus may be used for wireless communication networks such as code division multiple access (CDMA) networks, time division multiple access (TDMA) networks, frequency division multiple access (FDMA) networks, orthogonal FDMA (OFDMA) networks, single-carrier FDMA (SC-FDMA) networks, LTE networks, Global System for Mobile Communications (GSM) networks, 5^{th} Generation (5G) or new radio (NR) networks, as well as other communications networks. As described herein, the terms “networks” and “systems” may be used interchangeably.

An OFDMA network may implement a radio technology such as evolved UTRA (E-UTRA), Institute of Electrical and Electronics Engineers (IEEE) 802.11, IEEE 802.16, IEEE 802.20, flash-OFDM and the like. UTRA, E-UTRA, and GSM are part of universal mobile telecommunication system (UMTS). In particular, long term evolution (LTE) is a release of UMTS that uses E-UTRA. UTRA, E-UTRA, GSM, UMTS and LTE are described in documents provided from an organization named “3rd Generation Partnership Project” (3GPP), and cdma2000 is described in documents from an organization named “3rd Generation Partnership Project 2” (3GPP2). These various radio technologies and standards are known or are being developed. For example, the 3rd Generation Partnership Project (3GPP) is a collaboration between groups of telecommunications associations that aims to define a globally applicable third generation (3G) mobile phone specification. 3GPP long term evolution (LTE) is a 3GPP project which was aimed at improving the UMTS mobile phone standard. The 3GPP may define specifications for the next generation of mobile networks, mobile systems, and mobile devices. The present disclosure is concerned with the evolution of wireless technologies from LTE, 4G, 5G, NR, and beyond with shared access to wireless spectrum between networks using a collection of new and different radio access technologies or radio air interfaces.

In particular, 5G networks contemplate diverse deployments, diverse spectrum, and diverse services and devices that may be implemented using an OFDM-based unified, air interface. In order to achieve these goals, further enhancements to LTE and LTE-A are considered in addition to development of the new radio technology for 5G NR networks. The 5G NR will be capable of scaling to provide coverage (1) to a massive Internet of things (IoTs) with an Ultra-high density (e.g., ˜1M nodes/km²), ultra-low complexity (e.g., ˜10s of bits/sec), ultra-low energy (e.g., ˜10+ years of battery life), and deep coverage with the capability to reach challenging locations; (2) including mission-critical control with strong security to safeguard sensitive personal, financial, or classified information, ultra-high reliability (e.g., ˜99.9999% reliability), ultra-low latency (e.g., ˜1 ms), and users with wide ranges of mobility or lack thereof; and (3) with enhanced mobile broadband including extreme high capacity (e.g., ˜10 Tbps/km²), extreme data rates (e.g., multi-Gbps rate, 100+ Mbps user experienced rates), and deep awareness with advanced discovery and optimizations.

A 5G NR communication system may be implemented to use optimized OFDM-based waveforms with scalable numerology and transmission time interval (TTI); having a common, flexible framework to efficiently multiplex services and features with a dynamic, low-latency time division duplex (TDD)/frequency division duplex (FDD) design; and with advanced wireless technologies, such as massive multiple input, multiple output (MIMO), robust millimeter wave (mmWave) transmissions, advanced channel coding, and device-centric mobility. Scalability of the numerology in 5G NR, with scaling of subcarrier spacing, may efficiently address operating diverse services across diverse spectrum and diverse deployments. For example, in various outdoor and macro coverage deployments of less than 3GHz FDD/TDD implementations, subcarrier spacing may occur with 15 kHz, for example over 5, 10, 20 MHz, and the like bandwidth (BW). For other various outdoor and small cell coverage deployments of TDD greater than 3 GHz, subcarrier spacing may occur with 30 kHz over 80/100 MHz BW. For other various indoor wideband implementations, using a TDD over the unlicensed portion of the 5 GHz band, the subcarrier spacing may occur with 60 kHz over a 160 MHz BW. Finally, for various deployments transmitting with mm Wave components at a TDD of 28 GHz, subcarrier spacing may occur with 120 kHz over a 500 MHz BW. In certain aspects, frequency bands for 5G NR are separated into multiple different frequency ranges, a frequency range one (FR1), a frequency range two (FR2), and FR2x. FR1 bands include frequency bands at 7 GHz or lower (e.g., between about 410 MHz to about 7125 MHz). FR2 bands include frequency bands in mmWave ranges between about 24.25 GHz and about 52.6 GHz. FR2x bands include frequency bands in mmWave ranges between about 52.6 GHz to about 71 GHz. The mmWave bands may have a shorter range, but a higher bandwidth than the FR1 bands. Additionally, 5G NR may support different sets of subcarrier spacing for different frequency ranges.

The scalable numerology of the 5G NR facilitates scalable TTI for diverse latency and quality of service (QOS) requirements. For example, shorter TTI may be used for low latency and high reliability, while longer TTI may be used for higher spectral efficiency. The efficient multiplexing of long and short TTIs to allow transmissions to start on symbol boundaries. 5G NR also contemplates a self-contained integrated subframe design with UL/downlink scheduling information, data, and acknowledgement in the same subframe. The self-contained integrated subframe supports communications in unlicensed or contention-based shared spectrum, adaptive UL/downlink that may be flexibly configured on a per-cell basis to dynamically switch between UL and downlink to meet the current traffic needs.

Various other aspects and features of the disclosure are further described below. It should be apparent that the teachings herein may be embodied in a wide variety of forms and that any specific structure, function, or both being disclosed herein is merely representative and not limiting. Based on the teachings herein one of an ordinary level of skill in the art should appreciate that an aspect disclosed herein may be implemented independently of any other aspects and that two or more of these aspects may be combined in various ways. For example, an apparatus may be implemented or a method may be practiced using any number of the aspects set forth herein. In addition, such an apparatus may be implemented or such a method may be practiced using other structure, functionality, or structure and functionality in addition to or other than one or more of the aspects set forth herein. For example, a method may be implemented as part of a system, device, apparatus, and/or as instructions stored on a computer readable medium for execution on a processor or computer. Furthermore, an aspect may comprise at least one element of a claim.

The present disclosure describes systems and methods for nested discontinuous reception (DRX). Discontinuous reception is a method by which a device may be configured to only monitor for received communication during scheduled occasions, allowing the device to conserve power during the off durations. This is beneficial to low power devices. For energy harvesting devices, such as devices which charge via solar cells, longer DRX cycles may be beneficial in order to allow them to charge sufficiently between communication bursts. In some aspects of the present disclosure, an energy harvesting UE receives a data requirement from a network unit, indicating a number of operations the network device will perform with the UE during a DRX on cycle. For example, the network unit may specify a number of reference signal measurements, downlink communications, and uplink communications. The UE and/or network unit may have some predetermined information about the amount of energy required for each of these operations. Based on the requirement, the UE may determine suggested DRX parameters. Once determined, the UE may communicate the suggested DRX parameters to the network unit.

Alternatively, or in addition, the UE may transmit other information to the network unit so that the network unit may determine DRX parameters itself. For example, the UE may indicate a class of devices to which the UE belongs, about which the network unit has some predetermined information. The UE may also give energy harvesting capability information such as charging rate, charge capacity, and/or information about the amount of energy required to perform operations. Based on the information received from the UE, the network unit may determine final DRX parameters. Once determined (e.g., using either approach or both approaches), the network unit may transmit the final DRX parameters to the UE.

DRX parameters may include parameters for nested DRX operation, including both an inner DRX cycle configuration and an outer DRX cycle configuration. For example, the parameters may define the length and periodicity of both inner and outer DRX cycles. Generally, the outer DRX cycle length may be considerably longer than the inner DRX cycle length. This may allow for the UE to enter a lower power mode, or even a zero power mode, during the outer DRX cycle “off” duration than it is able to enter during the inner DRX cycle “off” duration.

Based on the final DRX parameters, the UE may monitor for signals from the network unit during the on durations of the inner DRX cycles within the on durations of the outer DRX cycles. The UE may request that the DRX parameters be updated by transmitting a message to the network unit. The message to the network unit may be a message that is sent periodically which includes suggested DRX parameters, or other energy harvesting capability information. In response, the network unit may transmit updated parameters to the UE. As part of the update process, the network unit may, in some aspects, first transmit updated data requirements to the UE.

Under certain circumstances, a UE may not charge sufficiently in time for a next DRX cycle “on” duration. In order to account for this, a UE may send an indication requesting that one or more DRX cycle “on” durations be skipped, allowing the UE more time to charge.

Systems and methods described herein provide many advantages. Providing for an outer DRX cycle allows a UE to enter into a lower power state during the outer DRX cycle “off” duration, granting the UE enough time to gather the requisite energy. The inner DRX cycle is beneficial in combination with the outer DRX cycle, in that it allows the UE to more efficiently use the energy it has gathered, by only monitoring for signals periodically during the outer DRX cycle “on” time according to the inner DRX cycle parameters. Using information about UE energy harvesting capability and network unit data requirements, the UE and/or network unit may determine DRX parameters that allow the UE to communicate as often as it can under the conditions, while allowing sufficient time to charge. The updating procedure allows for the network to adapt to changing conditions such as variable charging rates and/or changing data requirements.

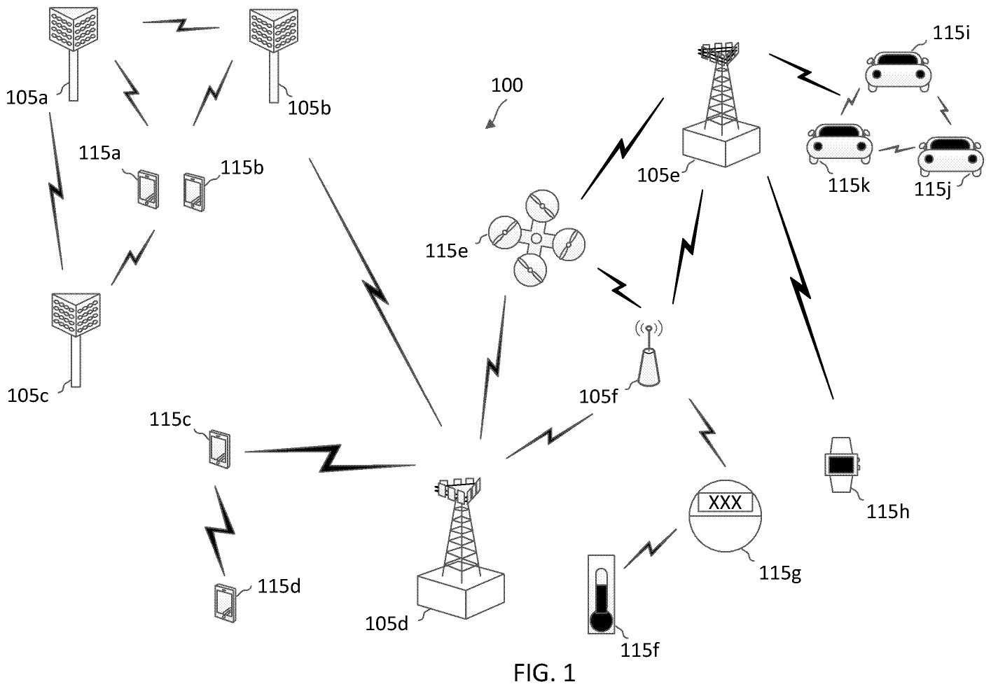

FIG. 1 illustrates a wireless communication network 100 according to some aspects of the present disclosure. The network 100 may be a 5G network. The network 100 includes a number of base stations (BSs) 105 (individually labeled as 105a, 105b, 105c, 105d, 105e, and 105f) and other network entities. A BS 105 may be a station that communicates with UEs 115 (individually labeled as 115a, 115b, 115c, 115d, 115e, 115f, 115g, 115h, and 115k) and may also be referred to as an evolved node B (eNB), a next generation eNB (gNB), an access point, and the like. Each BS 105 may provide communication coverage for a particular geographic area. In 3GPP, the term “cell” can refer to this particular geographic coverage area of a BS 105 and/or a BS subsystem serving the coverage area, depending on the context in which the term is used.

A BS 105 may provide communication coverage for a macro cell or a small cell, such as a pico cell or a femto cell, and/or other types of cell. A macro cell generally covers a relatively large geographic area (e.g., several kilometers in radius) and may allow unrestricted access by UEs with service subscriptions with the network provider. A small cell, such as a pico cell, would generally cover a relatively smaller geographic area and may allow unrestricted access by UEs with service subscriptions with the network provider. A small cell, such as a femto cell, would also generally cover a relatively small geographic area (e.g., a home) and, in addition to unrestricted access, may also provide restricted access by UEs having an association with the femto cell (e.g., UEs in a closed subscriber group (CSG), UEs for users in the home, and the like). A BS for a macro cell may be referred to as a macro BS. A BS for a small cell may be referred to as a small cell BS, a pico BS, a femto BS or a home BS. In the example shown in FIG. 1, the BSs 105d and 105e may be regular macro BSs, while the BSs 105a-105c may be macro BSs enabled with one of three dimension (3D), full dimension (FD), or massive MIMO. The BSs 105a-105c may take advantage of their higher dimension MIMO capabilities to exploit 3D beamforming in both elevation and azimuth beamforming to increase coverage and capacity. The BS 105f may be a small cell BS which may be a home node or portable access point. A BS 105 may support one or multiple (e.g., two, three, four, and the like) cells.

The network 100 may support synchronous or asynchronous operation. For synchronous operation, the BSs may have similar frame timing, and transmissions from different BSs may be approximately aligned in time. For asynchronous operation, the BSs may have different frame timing, and transmissions from different BSs may not be aligned in time.

The UEs 115 are dispersed throughout the wireless network 100, and each UE 115 may be stationary or mobile. A UE 115 may also be referred to as a terminal, a mobile station, a subscriber unit, a station, or the like. A UE 115 may be a cellular phone, a personal digital assistant (PDA), a wireless modem, a wireless communication device, a handheld device, a tablet computer, a laptop computer, a cordless phone, a wireless local loop (WLL) station, or the like. In one aspect, a UE 115 may be a device that includes a Universal Integrated Circuit Card (UICC). In another aspect, a UE may be a device that does not include a UICC. In some aspects, the UEs 115 that do not include UICCs may also be referred to as IoT devices or internet of everything (IoE) devices. The UEs 115a-115d are examples of mobile smart phone-type devices accessing network 100. A UE 115 may also be a machine specifically configured for connected communication, including machine type communication (MTC), enhanced MTC (eMTC), narrowband IoT (NB-IoT) and the like. The UEs 115e-115h are examples of various machines configured for communication that access the network 100. The UEs 115i-115k are examples of vehicles equipped with wireless communication devices configured for communication that access the network 100. A UE 115 may be able to communicate with any type of the BSs, whether macro BS, small cell, or the like. In FIG. 1, a lightning bolt (e.g., communication links) indicates wireless transmissions between a UE 115 and a serving BS 105, which is a BS designated to serve the UE 115 on the downlink (DL) and/or uplink (UL), desired transmission between BSs 105, backhaul transmissions between BSs, or sidelink transmissions between UEs 115.

In operation, the BSs 105a-105c may serve the UEs 115a and 115b using 3D beamforming and coordinated spatial techniques, such as coordinated multipoint (COMP) or multi-connectivity. The macro BS 105d may perform backhaul communications with the BSs 105a-105c, as well as small cell, the BS 105f. The macro BS 105d may also transmit multicast services which are subscribed to and received by the UEs 115c and 115d. Such multicast services may include mobile television or stream video, or may include other services for providing community information, such as weather emergencies or alerts, such as Amber alerts or gray alerts.

The BSs 105 may also communicate with a core network. The core network may provide user authentication, access authorization, tracking, Internet Protocol (IP) connectivity, and other access, routing, or mobility functions. At least some of the BSs 105 (e.g., which may be an example of a gNB or an access node controller (ANC)) may interface with the core network through backhaul links (e.g., NG-C, NG-U, etc.) and may perform radio configuration and scheduling for communication with the UEs 115. In various examples, the BSs 105 may communicate, either directly or indirectly (e.g., through core network), with each other over backhaul links (e.g., X1, X2, etc.), which may be wired or wireless communication links.

The network 100 may also support mission critical communications with ultra-reliable and redundant links for mission critical devices, such as the UE 115e, which may be a drone. Redundant communication links with the UE 115e may include links from the macro BSs 105d and 105e, as well as links from the small cell BS 105f. Other machine type devices, such as the UE 115f (e.g., a thermometer), the UE 115g (e.g., smart meter), and UE 115h (e.g., wearable device) may communicate through the network 100 either directly with BSs, such as the small cell BS 105f, and the macro BS 105e, or in multi-action-size configurations by communicating with another user device which relays its information to the network, such as the UE 115f communicating temperature measurement information to the smart meter, the UE 115g, which is then reported to the network through the small cell BS 105f. The network 100 may also provide additional network efficiency through dynamic, low-latency TDD/FDD communications, such as V2V, V2X, C-V2X communications between a UE 115i, 115j, or 115k and other UEs 115, and/or vehicle-to-infrastructure (V2I) communications between a UE 115i, 115j, or 115k and a BS 105.

In some implementations, the network 100 utilizes OFDM-based waveforms for communications. An OFDM-based system may partition the system BW into multiple (K) orthogonal subcarriers, which are also commonly referred to as subcarriers, tones, bins, or the like. Each subcarrier may be modulated with data. In some aspects, the subcarrier spacing between adjacent subcarriers may be fixed, and the total number of subcarriers (K) may be dependent on the system BW. The system BW may also be partitioned into subbands. In other aspects, the subcarrier spacing and/or the duration of TTIs may be scalable.

In some aspects, the BSs 105 can assign or schedule transmission resources (e.g., in the form of time-frequency resource elements (RE) and resource blocks (RB)) for downlink (DL) and uplink (UL) transmissions in the network 100. DL refers to the transmission direction from a BS 105 to a UE 115, whereas UL refers to the transmission direction from a UE 115 to a BS 105. The communication can be in the form of radio frames. A radio frame may be divided into a plurality of subframes or slots, for example, about 10. Each slot may be further divided into mini-slots. In a FDD mode, simultaneous UL and DL transmissions may occur in different frequency bands. For example, each subframe includes an UL subframe in an UL frequency band and a DL subframe in a DL frequency band. In a TDD mode, UL and DL transmissions occur at different time periods using the same frequency band. For example, a subset of the subframes (e.g., DL subframes) in a radio frame may be used for DL transmissions and another subset of the subframes (e.g., UL subframes) in the radio frame may be used for UL transmissions.

The DL subframes and the UL subframes can be further divided into several regions. For example, each DL or UL subframe may have pre-defined regions for transmissions of reference signals, control information, and data. Reference signals are predetermined signals that facilitate the communications between the BSs 105 and the UEs 115. For example, a reference signal can have a particular pilot pattern or structure, where pilot tones may span across an operational BW or frequency band, each positioned at a pre-defined time and a pre-defined frequency. For example, a BS 105 may transmit cell specific reference signals (CRSs) and/or channel state information-reference signals (CSI-RSs) to enable a UE 115 to estimate a DL channel. Similarly, a UE 115 may transmit sounding reference signals (SRSs) to enable a BS 105 to estimate an UL channel. Control information may include resource assignments and protocol controls. Data may include protocol data and/or operational data. In some aspects, the BSs 105 and the UEs 115 may communicate using self-contained subframes. A self-contained subframe may include a portion for DL communication and a portion for UL communication. A self-contained subframe can be DL-centric or UL-centric. A DL-centric subframe may include a longer duration for DL communication than for UL communication. an UL-centric subframe may include a longer duration for UL communication than for UL communication.

In some aspects, the network 100 may be an NR network deployed over a licensed spectrum. The BSs 105 can transmit synchronization signals (e.g., including a primary synchronization signal (PSS) and a secondary synchronization signal (SSS)) in the network 100 to facilitate synchronization. The BSs 105 can broadcast system information associated with the network 100 (e.g., including a system information block (SIB), a master information block (MIB), remaining system information (RMSI), and other system information (OSI)) to facilitate initial network access. In some aspects, the BSs 105 may broadcast the PSS, the SSS, and/or the MIB in the form of synchronization signal block (SSBs) and may broadcast the RMSI and/or the OSI over a physical downlink shared channel (PDSCH). The MIB may be transmitted over a physical broadcast channel (PBCH).

In some aspects, a UE 115 attempting to access the network 100 may perform an initial cell search by detecting a PSS from a BS 105. The PSS may enable synchronization of period timing and may indicate a physical layer identity value. The UE 115 may then receive a SSS. The SSS may enable radio frame synchronization, and may provide a cell identity value, which may be combined with the physical layer identity value to identify the cell. The PSS and the SSS may be located in a central portion of a carrier or any suitable frequencies within the carrier.

After receiving the PSS and SSS, the UE 115 may receive a MIB. The MIB may include system information for initial network access and scheduling information for RMSI and/or OSI. After decoding the MIB, the UE 115 may receive RMSI and/or OSI. The RMSI and/or OSI may include radio resource control (RRC) information related to random access channel (RACH) procedures, paging, control resource set (CORESET) for physical downlink control channel (PDCCH) monitoring, physical UL control channel (PUCCH), physical UL shared channel (PUSCH), power control, and SRS.

PDCCH monitoring may be configured such that a UE 115 does not need to continuously monitor PDCCH, but uses discontinuous reception (DRX). Doing so allows for a UE 115 to save power. A UE 115 may be configured by a BS 105 with nested DRX cycles, including an outer DRX cycle and an inner DRX cycle. DRX parameters may define the periodicity and length of both the inner and outer DRX cycles. In some aspects, the nested DRX cycles may be configured, for example, via RRC or DCI messaging.

Some UEs 115 may be energy harvesting UEs. An energy harvesting UE 115 may harvest energy from one or more sources. For example, solar, vibration, thermal, and/or RF energy may be harvested. Based on an energy harvesting capability of a UE 115, information about energy consumption for performing different operations, and data (communication) requirements of the network, the UE 115 and/or a BS 105 may determine nested DRX parameters. For example, a wearable device such as UE 115h may harvest vibrational energy. UE 115h may determine recommended DRX parameters based on information about charging rate, charging capacity, and the received data requirements. UE 115h may also transmit the information it has about itself to a network unit such as BS 105e, such that BS 105e may determine final DRX parameters.

After obtaining the MIB, the RMSI and/or the OSI, the UE 115 can perform a random access procedure to establish a connection with the BS 105. In some examples, the random access procedure may be a four-step random access procedure. For example, the UE 115 may transmit a random access preamble and the BS 105 may respond with a random access response. The random access response (RAR) may include a detected random access preamble identifier (ID) corresponding to the random access preamble, timing advance (TA) information, an UL grant, a temporary cell-radio network temporary identifier (C-RNTI), and/or a backoff indicator. Upon receiving the random access response, the UE 115 may transmit a connection request to the BS 105 and the BS 105 may respond with a connection response. The connection response may indicate a contention resolution. In some examples, the random access preamble, the RAR, the connection request, and the connection response can be referred to as message 1 (MSG1), message 2 (MSG2), message 3 (MSG3), and message 4 (MSG4), respectively. In some examples, the random access procedure may be a two-step random access procedure, where the UE 115 may transmit a random access preamble and a connection request in a single transmission and the BS 105 may respond by transmitting a random access response and a connection response in a single transmission.

After establishing a connection, the UE 115 and the BS 105 can enter a normal operation stage, where operational data may be exchanged. For example, the BS 105 may schedule the UE 115 for UL and/or DL communications. The BS 105 may transmit UL and/or DL scheduling grants to the UE 115 via a PDCCH. The scheduling grants may be transmitted in the form of DL control information (DCI). The BS 105 may transmit a DL communication signal (e.g., carrying data) to the UE 115 via a PDSCH according to a DL scheduling grant. The UE 115 may transmit an UL communication signal to the BS 105 via a PUSCH and/or PUCCH according to an UL scheduling grant. The connection may be referred to as an RRC connection. When the UE 115 is actively exchanging data with the BS 105, the UE 115 is in an RRC connected state. The UE 115 may enter an idle or inactive RRC state when not exchanging data with the BS 105.

In an example, after establishing a connection with the BS 105, the UE 115 may initiate an initial network attachment procedure with the network 100. The BS 105 may coordinate with various network entities or fifth generation core (5GC) entities, such as an access and mobility function (AMF), a serving gateway (SGW), and/or a packet data network gateway (PGW), to complete the network attachment procedure. For example, the BS 105 may coordinate with the network entities in the 5GC to identify the UE, authenticate the UE, and/or authorize the UE for sending and/or receiving data in the network 100. In addition, the AMF may assign the UE with a group of tracking areas (TAs). Once the network attach procedure succeeds, a context is established for the UE 115 in the AMF. After a successful attach to the network, the UE 115 can move around the current TA. For tracking area update (TAU), the BS 105 may request the UE 115 to update the network 100 with the UE 115's location periodically. Alternatively, the UE 115 may only report the UE 115's location to the network 100 when entering a new TA. The TAU allows the network 100 to quickly locate the UE 115 and page the UE 115 upon receiving an incoming data packet or call for the UE 115.

In some aspects, the BS 105 may communicate with a UE 115 using HARQ techniques to improve communication reliability, for example, to provide a URLLC service. The BS 105 may schedule a UE 115 for a PDSCH communication by transmitting a DL grant in a PDCCH. The BS 105 may transmit a DL data packet to the UE 115 according to the schedule in the PDSCH. The DL data packet may be transmitted in the form of a transport block (TB). If the UE 115 receives the DL data packet successfully, the UE 115 may transmit a HARQ ACK to the BS 105. Conversely, if the UE 115 fails to receive the DL transmission successfully, the UE 115 may transmit a HARQ NACK to the BS 105. Upon receiving a HARQ NACK from the UE 115, the BS 105 may retransmit the DL data packet to the UE 115. The retransmission may include the same coded version of DL data as the initial transmission. Alternatively, the retransmission may include a different coded version of the DL data than the initial transmission. The UE 115 may apply soft combining to combine the encoded data received from the initial transmission and the retransmission for decoding. The BS 105 and the UE 115 may also apply HARQ for UL communications using substantially similar mechanisms as the DL HARQ.

In some aspects, the network 100 may operate over a system BW or a component carrier (CC) BW. The network 100 may partition the system BW into multiple BWPs (e.g., portions). A BS 105 may dynamically assign a UE 115 to operate over a certain BWP (e.g., a certain portion of the system BW). The assigned BWP may be referred to as the active BWP. The UE 115 may monitor the active BWP for signaling information from the BS 105. The BS 105 may schedule the UE 115 for UL or DL communications in the active BWP. In some aspects, a BS 105 may assign a pair of BWPs within the CC to a UE 115 for UL and DL communications. For example, the BWP pair may include one BWP for UL communications and one BWP for DL communications.

In some aspects, the network 100 may operate over a shared channel, which may include shared frequency bands and/or unlicensed frequency bands. For example, the network 100 may be an NR-U network operating over an unlicensed frequency band. In such an aspect, the BSs 105 and the UEs 115 may be operated by multiple network operating entities. To avoid collisions, the BSs 105 and the UEs 115 may employ a listen-before-talk (LBT) procedure to monitor for transmission opportunities (TXOPs) in the shared channel. A TXOP may also be referred to as COT. The goal of LBT is to protect reception at a receiver from interference. For example, a transmitting node (e.g., a BS 105 or a UE 115) may perform an LBT prior to transmitting in the channel. When the LBT passes, the transmitting node may proceed with the transmission. When the LBT fails, the transmitting node may refrain from transmitting in the channel.

An LBT can be based on energy detection (ED) or signal detection. For an energy detection-based LBT, the LBT results in a pass when signal energy measured from the channel is below a threshold. Conversely, the LBT results in a failure when signal energy measured from the channel exceeds the threshold. For a signal detection-based LBT, the LBT results in a pass when a channel reservation signal (e.g., a predetermined preamble signal) is not detected in the channel.

Additionally, an LBT may be in a variety of modes. An LBT mode may be, for example, a category 4 (CAT4) LBT, a category 2 (CAT2) LBT, or a category 1 (CAT1) LBT. A CAT1 LBT is referred to a no LBT mode, where no LBT is to be performed prior to a transmission. A CAT2 LBT refers to an LBT without a random backoff period. For instance, a transmitting node may determine a channel measurement in a time interval and determine whether the channel is available or not based on a comparison of the channel measurement against a ED threshold. A CAT4 LBT refers to an LBT with a random backoff and a variable contention window (CW). For instance, a transmitting node may draw a random number and backoff for a duration based on the drawn random number in a certain time unit.

Deployment of communication systems, such as 5G new radio (NR) systems, may be arranged in multiple manners with various components or constituent parts. In a 5G NR system, or network, a network node, a network entity, a network unit, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS 105 (such as a Node B (NB), evolved NB (eNB), NR BS, 5G NB, access point (AP), a transmit receive point (TRP), or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUs)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU also can be implemented as virtual units, i.e., a virtual central unit (VCU), a virtual distributed unit (VDU), or a virtual radio unit (VRU).

Base station-type operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

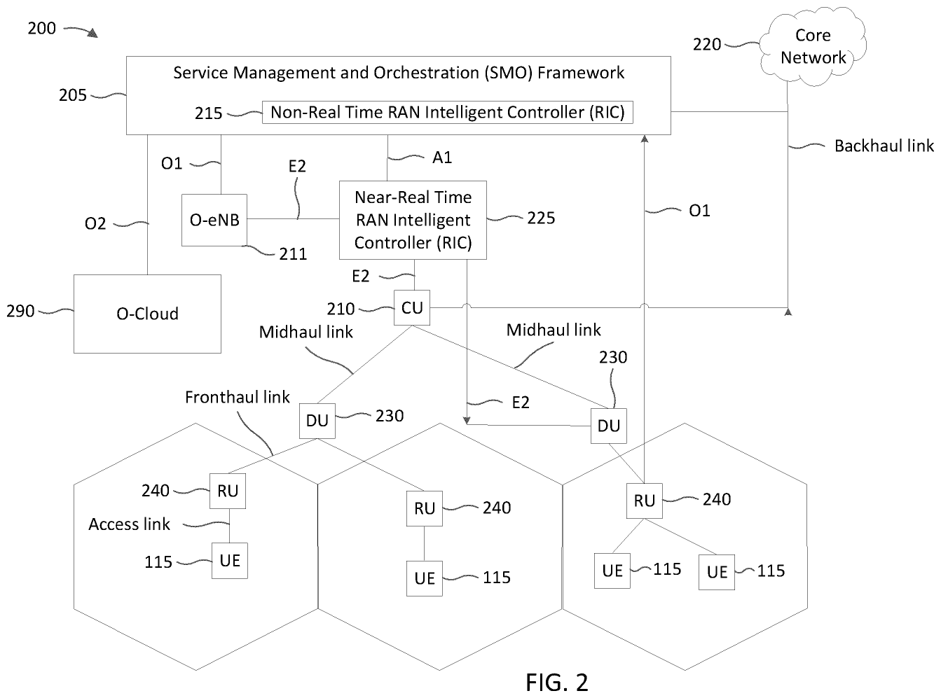

FIG. 2 shows a diagram illustrating an example disaggregated base station 200 architecture. The disaggregated base station 200 architecture may include one or more central units (CUs) 210 that can communicate directly with a core network 220 via a backhaul link, or indirectly with the core network 220 through one or more disaggregated base station units (such as a Near-Real Time (Near-RT) RAN Intelligent Controller (RIC) 225 via an E2 link, or a Non-Real Time (Non-RT) RIC 215 associated with a Service Management and Orchestration (SMO) Framework 205, or both). A CU 210 may communicate with one or more distributed units (DUs) 230 via respective midhaul links, such as an F1 interface. The DUs 230 may communicate with one or more radio units (RUs) 240 via respective fronthaul links. The RUs 240 may communicate with respective UEs 115 via one or more radio frequency (RF) access links. In some implementations, the UE 115 may be simultaneously served by multiple RUs 240.

Each of the units, i.e., the CUs 210, the DUs 230, the RUs 240, as well as the Near-RT RICs 225, the Non-RT RICs 215 and the SMO Framework 205, may include one or more interfaces or be coupled to one or more interfaces configured to receive or transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or transmit signals over a wired transmission medium to one or more of the other units. Additionally, the units can include a wireless interface, which may include a receiver, a transmitter or transceiver (such as a radio frequency (RF) transceiver), configured to receive or transmit signals, or both, over a wireless transmission medium to one or more of the other units.

In some aspects, the CU 210 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 210. The CU 210 may be configured to handle user plane functionality (i.e., Central Unit-User Plane (CU-UP)), control plane functionality (i.e., Central Unit-Control Plane (CU-CP)), or a combination thereof. In some implementations, the CU 210 can be logically split into one or more CU-UP units and one or more CU-CP units. The CU-UP unit can communicate bidirectionally with the CU-CP unit via an interface, such as the El interface when implemented in an O-RAN configuration. The CU 210 can be implemented to communicate with the DU 230, as necessary, for network control and signaling.

The DU 230 may correspond to a logical unit that includes one or more base station functions to control the operation of one or more RUs 240. In some aspects, the DU 230 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the 3rd Generation Partnership Project (3GPP). In some aspects, the DU 230 may further host one or more low PHY layers. Each layer (or module) can be implemented with an interface configured to communicate signals with other layers (and modules) hosted by the DU 230, or with the control functions hosted by the CU 210.

Lower-layer functionality can be implemented by one or more RUs 240. In some deployments, an RU 240, controlled by a DU 230, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 240 can be implemented to handle over the air (OTA) communication with one or more UEs 115. In some implementations, real-time and non-real-time aspects of control and user plane communication with the RU(s) 240 can be controlled by the corresponding DU 230. In some scenarios, this configuration can enable the DU(s) 230 and the CU 210 to be implemented in a cloud-based RAN architecture, such as a vRAN architecture.

The SMO Framework 205 may be configured to support RAN deployment and provisioning of non-virtualized and virtualized network elements. For non-virtualized network elements, the SMO Framework 205 may be configured to support the deployment of dedicated physical resources for RAN coverage requirements which may be managed via an operations and maintenance interface (such as an O1 interface). For virtualized network elements, the SMO Framework 205 may be configured to interact with a cloud computing platform (such as an open cloud (O-Cloud) 290) to perform network element life cycle management (such as to instantiate virtualized network elements) via a cloud computing platform interface (such as an O2 interface). Such virtualized network elements can include, but are not limited to, CUs 210, DUs 230, RUs 240 and Near-RT RICs 225. In some implementations, the SMO Framework 205 can communicate with a hardware aspect of a 4G RAN, such as an open eNB (O-eNB) 211, via an O1 interface. Additionally, in some implementations, the SMO Framework 205 can communicate directly with one or more RUs 240 via an O1 interface. The SMO Framework 205 also may include a Non-RT RIC 215 configured to support functionality of the SMO Framework 205.

The Non-RT RIC 215 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 225. The Non-RT RIC 215 may be coupled to or communicate with (such as via an A1 interface) the Near-RT RIC 225. The Near-RT RIC 225 may be configured to include a logical function that enables near-real-time control and optimization of RAN elements and resources via data collection and actions over an interface (such as via an E2 interface) connecting one or more CUs 210, one or more DUs 230, or both, as well as an O-eNB, with the Near-RT RIC 225.

In some implementations, to generate AI/ML models to be deployed in the Near-RT RIC 225, the Non-RT RIC 215 may receive parameters or external enrichment information from external servers. Such information may be utilized by the Near-RT RIC 225 and may be received at the SMO Framework 205 or the Non-RT RIC 215 from non-network data sources or from network functions. In some examples, the Non-RT RIC 215 or the Near-RT RIC 225 may be configured to tune RAN behavior or performance. For example, the Non-RT RIC 215 may monitor long-term trends and patterns for performance and employ AI/ML models to perform corrective actions through the SMO Framework 205 (such as reconfiguration via 01) or via creation of RAN management policies (such as A1 policies).

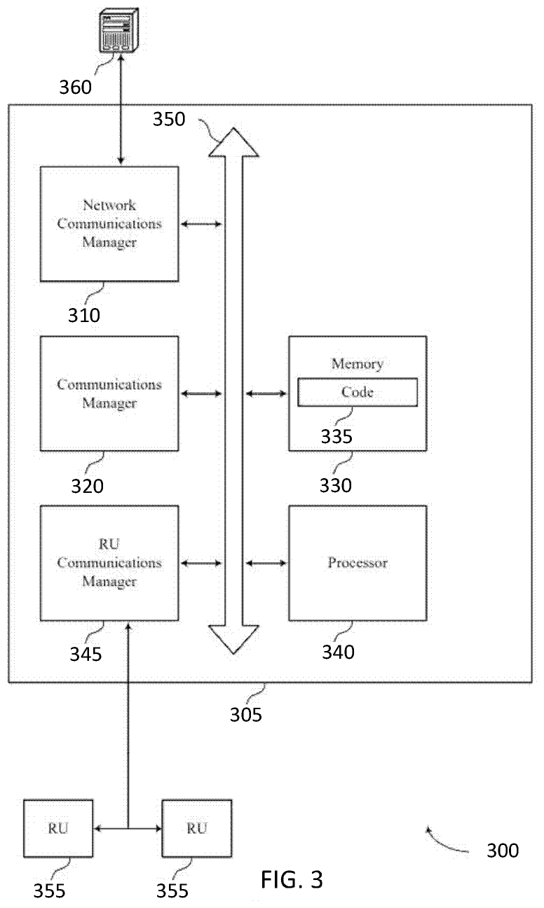

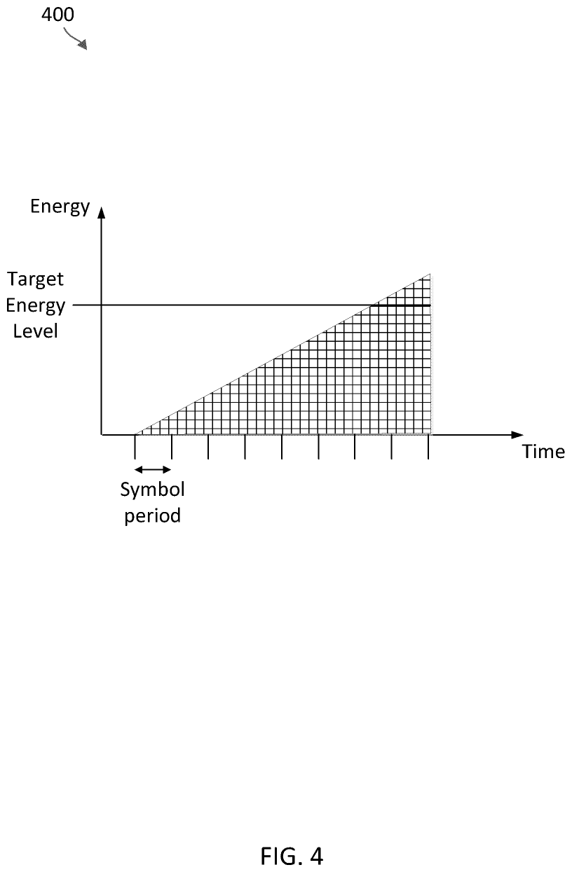

FIG. 3 shows a diagram of a system 300 including a device 305 that supports RU sharing techniques in wireless communications in accordance with aspects of the present disclosure. The device 305 may communicate with one or more RUs 355. The device 305 may include components for bi-directional voice and data communications including components for transmitting and receiving communications, such as a communications manager 320, a network communications manager 310, a memory 330, code 335, a processor 340, and a RU communications manager 345. These components may be in electronic communication or otherwise coupled (e.g., operatively, communicatively, functionally, electronically, electrically) via one or more buses (e.g., a bus 350). One or more of the components of system 300 may perform functions as described herein with reference to FIGS. 4-12, for example functions described as performed by a base station or network unit.

The network communications manager 310 may manage communications with a core network 360 (e.g., via one or more wired backhaul links). For example, the network communications manager 310 may manage the transfer of data communications for client devices, such as one or more UEs 115.

The memory 330 may include RAM and ROM. The memory 330 may store computer-readable, computer-executable code 335 including instructions that, when executed by the processor 340, cause the device 305 to perform various functions described herein. The code 335 may be stored in a non-transitory computer-readable medium such as system memory or another type of memory. In some cases, the code 335 may not be directly executable by the processor 340 but may cause a computer (e.g., when compiled and executed) to perform functions described herein. In some cases, the memory 330 may contain, among other things, a BIOS which may control basic hardware or software operation such as the interaction with peripheral components or devices.

The processor 340 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 340 may be configured to operate a memory array using a memory controller. In some other cases, a memory controller may be integrated into the processor 340. The processor 340 may be configured to execute computer-readable instructions stored in a memory (e.g., the memory 330) to cause the device 305 to perform various functions (e.g., functions or tasks supporting RU sharing techniques in wireless communications). For example, the device 305 or a component of the device 305 may include a processor 340 and memory 330 coupled to the processor 340, the processor 340 and memory 330 configured to perform various functions described herein.

The RU communications manager 345 may manage communications with RUs 355, and may include a controller or scheduler for controlling communications with UEs 115 in cooperation with RUs 355. For example, the RU communications manager 345 may coordinate scheduling for transmissions to UEs 115. In some examples, the RU communications manager 345 may provide an F1 interface within a wireless communications network technology to provide communication with RUs 355.

The communications manager 320 may support wireless communications at a network node in accordance with examples as disclosed herein. For example, the communications manager 320 may be configured as or otherwise support a means for transmitting, to a first RU, a request for a wireless resource configuration for a first time period. The communications manager 320 may be configured as or otherwise support a means for transmitting, to a second RU, an interference inquiry associated with the wireless resource configuration for the first time period. The communications manager 320 may be configured as or otherwise support a means for receiving, from the second RU, a response to the interference inquiry. The communications manager 320 may be configured as or otherwise support a means for transmitting, based on the response to the interference inquiry, a payload to the first RU for transmission during the first time period.

By including or configuring the communications manager 320 in accordance with examples as described herein, the device 305 may support techniques for RU sharing in which DUs of different MNOs may access wireless resources of other MNOs, which may increase efficiency of resource usage while provide for competition and innovation among different MNOs, may increase the reliability of wireless communications, decrease latency, and enhance user experience.

In some examples, the communications manager 320 may be configured to perform various operations (e.g., receiving, monitoring, transmitting) using or otherwise in cooperation with other components. Although the communications manager 320 is illustrated as a separate component, in some examples, one or more functions described with reference to the communications manager 320 may be supported by or performed by the processor 340, the memory 330, the code 335, or any combination thereof. For example, the code 335 may include instructions executable by the processor 340 to cause the device 305 to perform various aspects of RU sharing techniques in wireless communications as described herein, or the processor 340 and the memory 330 may be otherwise configured to perform or support such operations.

FIG. 4 illustrates a simplified diagram 400 of an energy charging scheme according to some aspects of the present disclosure. Diagram 400 represents charging by an energy harvesting UE 115. The vertical axis represents energy in some units, and the horizontal axis represents time in some units. The hashed portion of the graph represents the accumulating energy over time as harvested by an energy harvesting UE 115. The horizontal axis is divided into symbol periods, which is the granularity with which communication occurs with the energy harvesting UE 115.

As illustrated in diagram 400, a target energy level may be defined. The target energy level may be determined based on a data requirement indicated by a network unit such as a BS 105. For example, a BS 105 may determine that for each outer DRX cycle “on” duration, the UE 115 will transmit a certain number of uplink messages, receive a certain number of downlink messages, and perform one or more other processing operations. The energy of a downlink message (associated with one or more downlink (DL) DL DCI messages) may be based on the number of demodulation reference signal (DMRS) resource elements, number of data resource elements, used modulation and coding scheme (MCS), number of resource elements of a control channel (DL DCI), control channel format (which DCI format), search space of the control channel, aggregation level of the control message, and/or the number of DMRS resource elements of the control channel.

The energy of an uplink message (associated with one or more UL DCI messages) can be based on the transmit power level of the UE 115, DMRS resource elements, number of data resource elements, used modulation and coding scheme (MCS), number of resource elements of a control channel, control channel format, search space of control channel, aggregation level of the control message, and/or number of DMRS resource elements of the control channel.

The BS 105 may also have information about how much energy is used by the UE 115 in performing those operations. The information may be determined by BS 105 receiving a base value of consumed power or energy by UE 115 for each downlink channel per resource element for each MCS or downlink channel per bit and for one or more power levels for each uplink channel per resource element (or per a reference/agreed time/frequency block of resources) for each MCS or per bit. The cost can change based on the density of DMRS. The power information could also include power consumption per resource element for each type of signal (DMRS, data with each MCS value, reference signal such as CSI-RS or SSB or any other). The number of REs/RBs per transmission may be partially a function of an agreed transport block size (TBS). Using this power model, and an agreed number of REs/RBs per transmission, the BS 105 can compute the power/energy consumed by UE 115 to do downlink or uplink processing. Uplink transmit power level may affect the consumed power, so the BS 105 may compute the consumed power based on an agreed or otherwise known uplink transmit power level.

In some aspects, the total energy consumption is a linear function of the total number of resources. For example. assuming the base function of a downlink channel (e.g., data channel) is P_MCS for a given MCS (MCSx) and the number of resources is L (including both time and frequency resources), then total power may be computed as P_MCSx*L. In other cases, it could be a non-linear function that changes based on number of frequency elements and time elements, e.g., F(P_MCSx,L) where F is a non-linear function. In another cases, it can also depend on operation frequency band where in the function can depend on band as well as the base value, e.g., F(P,L, band) or F(P_MCSx(Band),L,band). Note that the base values (the total energy cost using the base value and the total number of elements) could be a function of the current frequency band of operations. For example, there could be different energy cost for different frequency bands.

In other aspects or additionally, the mapping function could be also a function of the current frequency band of operations. For example, there could be different energy cost for different frequency bands. The base values or the functions could be also a function of band, band combination, component carrier (CC), CC combination, BWP, and/or BWP combination. In some examples, the processing energy can also depend on frequency and time dimensions, not only the number of REs/RBs. For example, if the number of frequency resource elements is L_f for a given OFDM symbol and the number of OFDM symbols is L_t, the energy/power cost of processing an UL or DL channel could be F^DL(PADL_MCSx,L_f,L_t) and F^UL(PAUL_MCSx,L_f,L_t) where F^DL(.) and F^UL(.) are the mapping (linear or non-linear) functions between base values and the communication parameters. In the previous example, it is assumed that the UL and DL transmissions will have the same MCS, number of resource elements per OFDM symbol, and number of OFDM symbols.

The transmit power level for UL transmission may impact or be part of a base value PAUL or can be added as an input to the mapping (linear/non-linear) function. If BS 105 will configure the DRX configuration and will determine the time values (T1_inner, T2_inner, T1_outer, T2_outer) based on certain requirements, then it may base values and the mapping function(s) across all channels for different operation bands (or at least for the current band) and for the combination of bands/CCs/BWPs.

UE 115 may also perform radio resource management (RRM) within the serving cell, hence, it may monitor SSB for serving cell, hence, it may measure SSB. The power/energy cost of measuring and processing SSB per resource element (or per reference/agreed time/frequency block) may be agreed (if BS 105 computes the parameters) then based on the actual number of resource elements, the energy cost may be computed. Similar considerations may be taken into account for CSI-RS monitoring/measurement and CSI reporting (UL transmission). In addition, the same considerations may be taken for SRS (sounding signals from UE to gNB) transmission. Both CSI-RS and SRS may be periodic, aperiodic, or semi-persistent, and they can be part of the data requirements. The cost functions and base values for those reference signals (SSB/CSI-RS/SRS) could be different from those involving data or control signals. This is because during data decoding (PDSCH reception and decoding), a low-density parity check (LDPC) decoder may operate, similarly a polar decoder may operate to decode PDCCH (e.g., DCI). Moreover, during UL (e.g., PUSCH transmission), an LDPC encoder operates for data encoding, and during UCI transmissions for some PUCCH formats (e.g., formats beyond PUCCH format 0), a polar encoder operates.

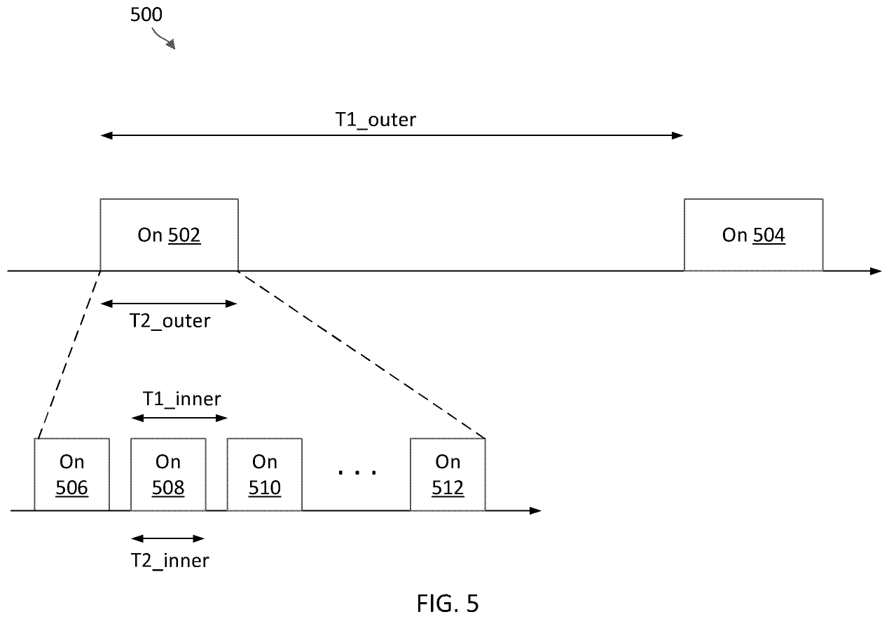

Using this information, the BS 105 may determine a target energy level to which the UE will ideally charge between outer DRX cycle “on” durations so that during the “on” duration the UE has sufficient energy stored to perform the desired operations. The time needed by the UE 115 to charge to the target energy level, and the nested DRX cycle parameters, may be defined in units of symbol periods as shown. An exemplary nested DRX cycle is discussed below with reference to FIG. 5.

FIG. 5 illustrates a simplified diagram 500 of a nested DRX scheme which may be used by a UE 115 according to some aspects of the present disclosure. The horizontal axis represents time in some units, with the lower portion of the diagram representing a zoomed-in section of the upper portion of the diagram, as indicated by the dashed lines. The upper portion of the diagram represents an outer DRX cycle. The outer DRX cycle may be defined by two parameters. The first parameter, T1_outer, may define the periodicity of the outer DRX cycle “on” durations. As illustrated, T1_outer is the time from the start of On 502 to the start of On 504. The second parameter, T2_outer, may define the length in time of an outer DRX cycle “on” duration. The inner DRX cycle occurs during an “on” duration of the outer DRX cycle (e.g., On 502 or On 504 in FIG. 5's example).

Similar to the outer DRX cycle parameters, the inner DRX cycle may also be defined by two parameters. The first parameter, T1_inner, may define the periodicity of the inner DRX cycle “on” durations. As illustrated, T1_inner is the time from the start of On 508 to the start of On 510. Although not shown, the same time defined by T1_inner is the time between the start of On 506 to the start of On 508. The second parameter, T2_inner, may define the length in time of an inner DRX cycle “on” duration. A UE 115 configured with a nested DRX cycle may monitor for signals during inner DRX cycle “on” durations which occur within outer DRX cycle “on” durations. A UE 115 may further perform other operations such as transmissions and other processing as requested via received messages.

The inner DRX cycle may continue for the entire duration of a given outer DRX cycle on time (e.g., On 502 or On 504), which as shown ends with the last On 512 within the outer DRX cycle On 502. A UE 115 may enter into a lower power or zero power mode, or otherwise not monitor for transmissions between inner and outer DRX cycle “on” durations. A UE 115 may have sufficient time between outer DRX cycle “on” durations to enter into a lower power mode than it is able to achieve between inner DRX cycle “on” durations. The UE 115 may harvest energy between “on” durations, and in some aspects may also harvest energy during “on” durations.

In some aspects, UE 115 stay in RRC connected mode throughout the “on” and “off” durations of the inner and outer DRX cycles, and does not go to idle mode or inactive mode unless indicated by the BS 105 to do so. In some aspects, once indicated to go to inactive RRC, the UE 115 may be directed to use a timer to move to connected mode. Staying in RRC connected mode may apply based on the class of UE device, or may apply to all energy harvesting UE classes. Further, in some aspects, the UE 115 may use a timer to move to RRC IDLE mode.

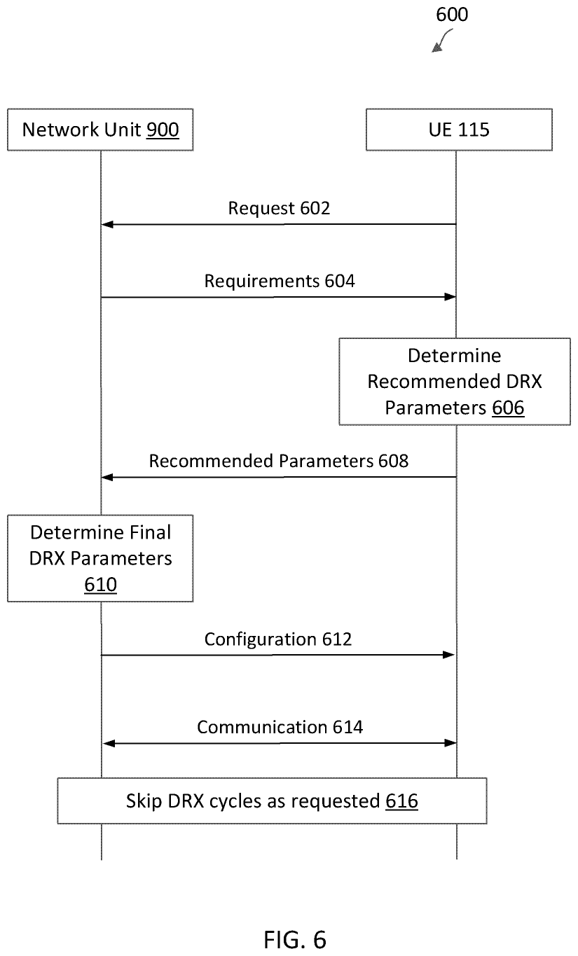

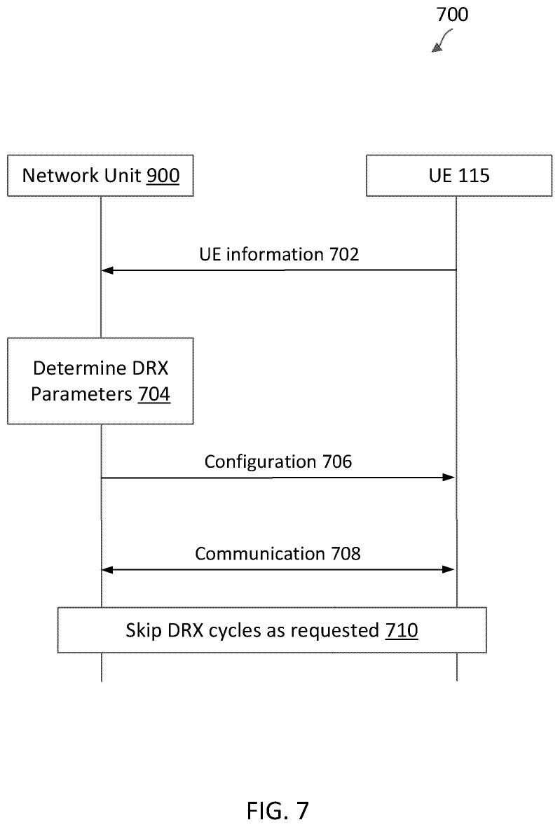

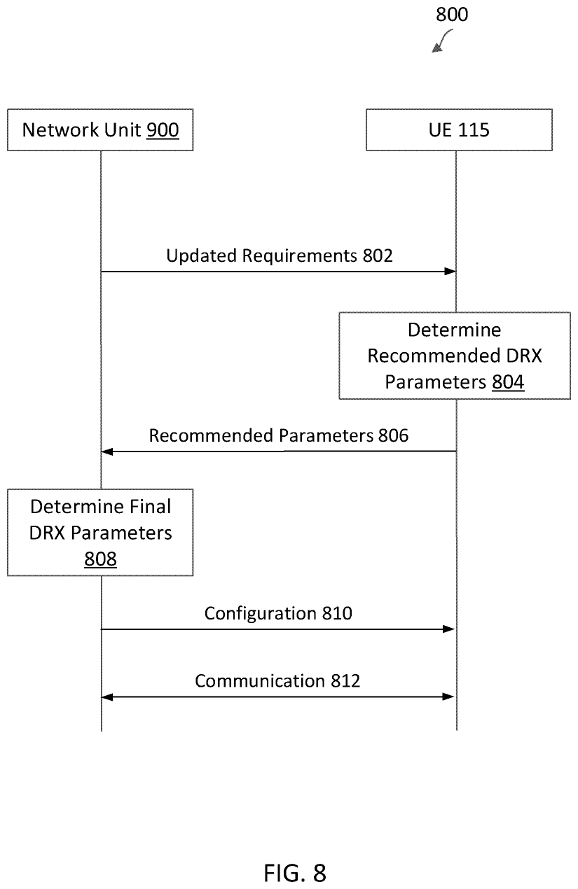

FIGS. 6-8 are signaling diagrams, illustrating different aspects of DRX configuration schemes including a network unit 900 and an energy harvesting UE 115. FIG. 6 represents a nested DRX configuration scheme where recommended DRX parameters are determined by the UE 115. FIG. 7 represents a nested DRX configuration scheme where the UE 115 transmits information, not necessarily recommended DRX parameters, on which the network unit bases the final DRX parameter determination. FIG. 8 represents a scheme for subsequently updating DRX parameters.

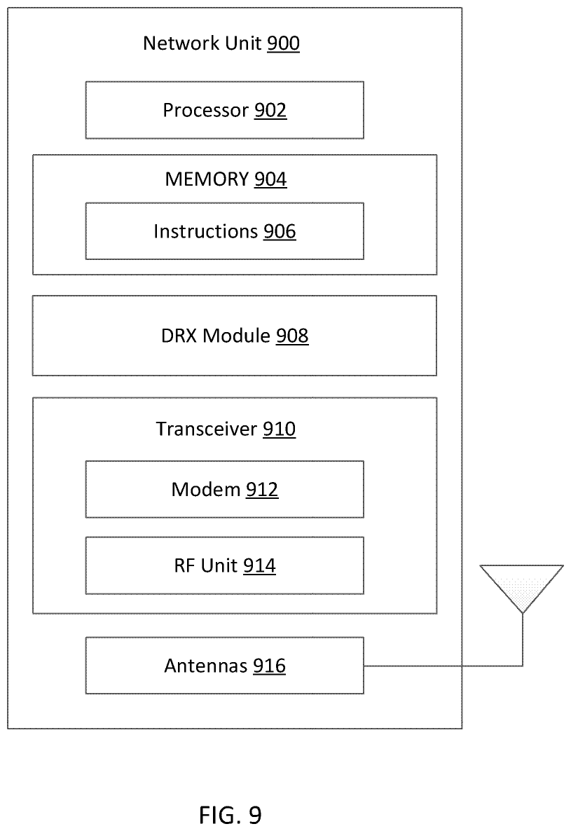

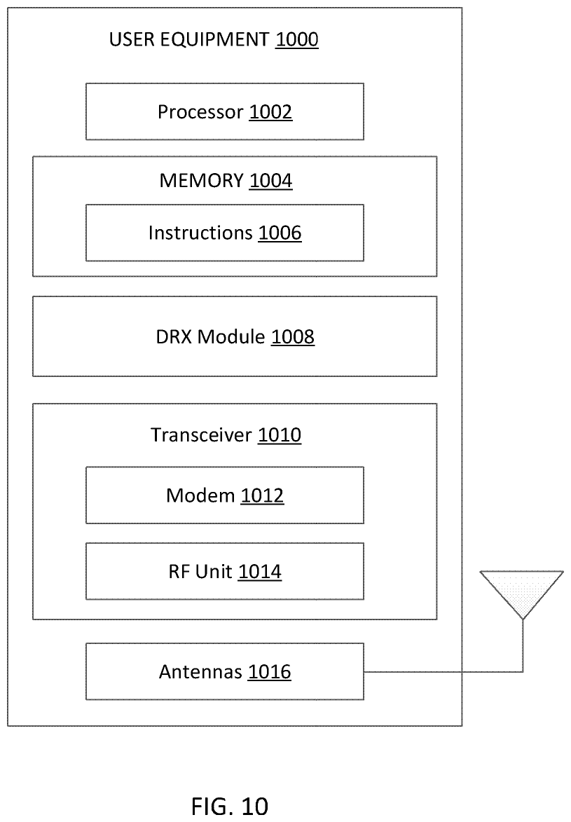

Referring now to FIG. 6, diagram 600 is employed by a network unit 900 such as a BS 105, discussed with reference to FIG. 1, one or more components of disaggregated base station 200 (e.g., CU 210, DU 230, and/or RU 240) discussed with reference to FIGS. 2-3. Network unit 601 may utilize one or more components, such as the processor 902, the memory 904, the DRX module 908, the transceiver 910, the modem 912, and the one or more antennas 916 shown in FIG. 9, and the UE 115 may utilize one or more components, such as the processor 1002, the memory 1004, the DRX module 1008, the transceiver 1010, the modem 1012, and the one or more antennas 1016 shown in FIG. 10. As illustrated, the signaling diagram 600 includes a number of enumerated actions, but aspects of FIG. 6 may include additional actions before, after, and in between the enumerated actions. In some aspects, one or more of the enumerated actions may be omitted, combined together, or performed in a different order.

At action 602, UE 115 transmits a request to network unit 900, for example via PUSCH or PUCCH. The request may be a request for a nested DRX configuration. In some aspects, the network unit 900 may initiate the procedure without a request from the UE 115 (such that action 602 is option).

At action 604, network unit 900 transmits requirements to UE 115. The requirements may include, for example, a number of PDSCH downlink transmissions, a number of PUSCH uplink transmissions, a number of measurements to perform, and/or other operations to be performed by the UE 115 during a DRX cycle. The requirements may be transmitted, for example, via PDSCH, via an RRC configuration, or a DCI message.

At action 606, UE 115 determines recommended DRX parameters. The determination may be based on the received requirements, in addition to information about UE 115 such as energy harvesting capability. For example, UE 115 may have a known charging rate, a known total charge capacity, and may also have information about the amount of energy it takes the UE 115 to perform different operations. For example, UE 115 may determine estimated energy usage of uplink transmissions, downlink transmission, radio resource management, etc. as discussed with respect to FIG. 4. UE 115 may determine the amount of energy required to perform all of the operations indicated in the requirements received at action 604, thereby computing a target energy level as discussed with reference to FIG. 4. Given the needed energy, UE 115 may then determine, based on the charging rate, etc., the amount of time (typically in increments of symbol periods) needed to charge. Based on these requirements and information, the UE 115 may determine the recommended DRX parameters which allow sufficient charging time.

At action 608, UE 115 transmits the recommended DRX parameters to network unit 900. The recommended parameters may be sent, for example, via PUSCH or PUCCH. The recommended parameters may include inner and outer DRX parameters as described with reference to FIG. 5 (i.e., T1_inner, T2_inner, T1_outer, and T2_outer). In some aspects, parameters may be communicated by providing an index into a table which includes predefined or preconfigured sets of parameters.

At action 610, network unit 900 determines final DRX parameters based on the recommended parameters received from UE 115. The final DRX parameters may include inner and outer DRX parameters as described with reference to FIG. 5 (i.e., T1_inner, T2_inner, T1_outer, and T2_outer). In some aspects, network unit 900 accepts the parameters recommended by UE 115. In other aspects, network unit 900 considers additional information such as scheduling of communication with other UEs 115, network performance, additional power requirements, etc. Based on the consideration, the final DRX parameters may be different than the recommended DRX parameters.

At action 612, network unit 900 configures UE 115 using the final DRX parameters. The configuration may be transmitted, for example, via PDCCH or PUSCH, as a DCI message, and/or an RRC configuration.

At action 614, network unit 900 and UE 115 communicate according to the configured nested DRX cycle, for example as described with reference to FIG. 5. UE 115 may monitor for signals during inner DRX cycle “on” durations which occur within outer DRX cycle “on” durations. UE 115 may further perform other operations such as transmissions and other processing as requested via received messages. For example, during an inner DRX cycle “on” duration, UE 115 may receive a DCI message which schedules subsequent PUSCH resources which UE 115 may use to transmit uplink messages to network unit 900. The scheduled transmissions may occur within, or outside of, the DRX cycle “on” durations.

At action 616, UE 115 may request certain DRX cycles be skipped, or that some parameter bee modified at least temporarily. UE 115 may transmit, for example during a first on duration of the inner DRX cycle within the on duration of the outer DRX cycle, a request to skip one or more DRX cycles. In some aspects, UE 115 requests to skip an indicated number of uplink transmissions per inner DRX cycle. In other aspects, UE 115 requests to skip an indicated number of downlink receptions per inner DRX cycle. In other aspects, UE 115 requests to skip an entire outer DRX cycle on duration. In yet further aspects, UE 115 requests to update one or more outer DRX cycle on time durations. Finally, UE 115 may request any combination of the above.

UE 115 may request skipping DRX cycles or modification of parameters such as outer DRX cycle on time duration in response to not charging sufficient energy between DRX “on” durations. Rather than attempt to communicate at the scheduled times according to the DRX parameters, the UE may request these changes to dynamically respond to changing circumstances.

In response to a request, network unit 900 may refrain from transmitting messages during the scheduled DRX “on” duration, and wait for the next available DRX “on” duration as requested by UE 115.

Referring now to FIG. 7, diagram 700 is employed by a network unit 900 such as a BS 105, discussed with reference to FIG. 1, one or more components of disaggregated base station 200 (e.g., CU 210, DU 230, and/or RU 240) discussed with reference to FIGS. 2-3. Network unit 601 may utilize one or more components, such as the processor 902, the memory 904, the DRX module 908, the transceiver 910, the modem 912, and the one or more antennas 916 shown in FIG. 9, and the UE 115 may utilize one or more components, such as the processor 1002, the memory 1004, the DRX module 1008, the transceiver 1010, the modem 1012, and the one or more antennas 1016 shown in FIG. 10. As illustrated, the signaling diagram 700 includes a number of enumerated actions, but aspects of FIG. 7 may include additional actions before, after, and in between the enumerated actions. In some aspects, one or more of the enumerated actions may be omitted, combined together, or performed in a different order.

At action 702, UE 115 transmits UE information, for example energy harvesting capability information, energy usage information (e.g., information regarding the energy usage of different operations as discussed with reference to FIG. 4), and/or a target energy level to network unit 900. The information may be indicated directly, and/or the UE 115 may indicate a class of devices to which the UE 115 belongs which is associated with known information. The class of devices may be explicitly signaled, or may be signaled as an index into a table which is available to the network unit 900. The UE information may be communicated, for example, via PUSCH or PUCCH. The information may be transmitted at the request of the network unit 900 or may be transmitted periodically based on a configuration and/or standard schedule.

At action 704, network unit 900 determines DRX parameters based on the UE information. Network unit 900 may also consider other factors such as scheduling of communication with other UEs 115, network performance, additional power requirements, etc. The determined DRX parameters may include inner and outer DRX parameters as described with reference to FIG. 5 (i.e., T1_inner, T2_inner, T1_outer, and T2_outer). Parameters may be selected so that the UE 115 has sufficient time between DRX cycle “on” durations to charge to an energy level necessary to perform all of the functions the network unit 900 intends for it to perform in a DRX cycle.

At action 706, network unit 900 configures UE 115 using the determined DRX parameters. The configuration may be transmitted, for example, via PDCCH or PUSCH, as a DCI message, and/or an RRC configuration.

At action 708, network unit 900 and UE 115 communicate according to the configured nested DRX cycle, for example as described with reference to FIG. 5. UE 115 may monitor for signals during inner DRX cycle “on” durations which occur within outer DRX cycle “on” durations. UE 115 may further perform other operations such as transmissions and other processing as requested via received messages. For example, during an inner DRX cycle “on” duration, UE 115 may receive a DCI message which schedules subsequent PUSCH resources which UE 115 may use to transmit uplink messages to network unit 900. The scheduled transmissions may occur within, or outside of, the DRX cycle “on” durations.

At action 710, UE 115 may request certain DRX cycles be skipped as described with reference to action 616 of FIG. 6.

UE 115 may request skipping DRX cycles or modification of parameters such as outer DRX cycle on time duration in response to not charging sufficient energy between DRX “on” durations. Rather than attempt to communicate at the scheduled times according to the DRX parameters, the UE may request these changes to dynamically respond to changing circumstances.

In response to a request, network unit 900 may refrain from transmitting messages during the scheduled DRX “on” duration, and wait for the next available DRX “on” duration as requested by UE 115.

Referring now to FIG. 8, diagram 800 is employed by a network unit 900 such as a BS 105, discussed with reference to FIG. 1, one or more components of disaggregated base station 200 (e.g., CU 210, DU 230, and/or RU 240) discussed with reference to FIGS. 2-3. Network unit 900 may utilize one or more components, such as the processor 902, the memory 904, the DRX module 908, the transceiver 910, the modem 912, and the one or more antennas 916 shown in FIG. 9, and the UE 115 may utilize one or more components, such as the processor 1002, the memory 1004, the DRX module 1008, the transceiver 1010, the modem 1012, and the one or more antennas 1016 shown in FIG. 10. As illustrated, the signaling diagram 800 includes a number of enumerated actions, but aspects of FIG. 8 may include additional actions before, after, and in between the enumerated actions. In some aspects, one or more of the enumerated actions may be omitted, combined together, or performed in a different order. The actions performed in diagram 800 may occur, for example, after the actions described in FIG. 6 or FIG. 7.

At action 802, network unit 900 transmits updated requirements to UE 115. The updated requirements may include, for example, modified values for the requirements transmitted as discussed with reference to FIG. 6. The updated requirements may be transmitted, for example, via PDSCH, via an RRC configuration, or a DCI message. Updated requirements may be transmitted any time there is a change, or may be re-transmitted periodically by network unit 900.

At action 804, UE 115 determines recommended DRX parameters. The determination may be based on the updated requirements, in addition to updated information about UE 115 such as energy harvesting capability, and energy usage information as described with reference to FIG. 4. UE 115 may have energy harvesting capability information which has changed since an initial DRX configuration was performed. For example, for solar energy harvesting, the charging rate may change throughout the day as sun and weather conditions change. Inherent qualities of the UE 115 may change over time as well, such as reduced charging capacity as a battery ages. Additional information may be determined over time as well, for example, changed or improved information about how much energy different operations take. Given all the updated requirements and information, UE 115 may determine the amount of energy required to perform all of the operations indicated in the requirements received at action 802. Given the needed energy, UE 115 may then determine, based on the charging rate, etc., the amount of time (typically in increments of symbol periods) needed to charge. Based on these requirements and information, the UE may determine the recommended DRX parameters which allow sufficient charging time.

At action 806, UE 115 transmits the recommended DRX parameters to network unit 900. The recommended parameters may be sent, for example, via PUSCH or PUCCH. The recommended parameters may include inner and outer DRX parameters as described with reference to FIG. 5 (i.e., T1_inner, T2_inner, T1_outer, and T2_outer).

In some aspects, rather than transmitting recommended DRX parameters, UE 115 may transmit UE information such as energy harvesting capability information and/or information about the amount of energy required to perform different actions. The information may be indicated directly, and/or the UE may indicate a class of devices to which the UE belongs which is associated with known information. In this scenario, the UE would also not need to determine the recommended DRX parameters at action 804, since the network unit 900 may determine DRX parameters itself based on the information provided. This is similar to the initial DRX configuration as described with respect to FIG. 7.

At action 808, network unit 900 determines final DRX parameters based on the recommended parameters received from UE 115, and/or the UE information provided. The final DRX parameters may include inner and outer DRX parameters as described with reference to FIG. 5 (i.e., T1_inner, T2_inner, T1_outer, and T2_outer). In some aspects, network unit 900 accepts the parameters recommended by UE 115. In other aspects, even when UE 115 provides recommended DRX parameters, network unit 900 considers additional information such as scheduling of communication with other UEs 115, network performance, additional power requirements, etc. Based on the determination, the final DRX parameters may be different than the recommended DRX parameters.

At action 810, network unit 900 configures UE 115 using the final DRX parameters. The configuration may be transmitted, for example, via PDCCH or PUSCH, as a DCI message, and/or an RRC configuration.

At action 812, network unit 900 and UE 115 communicate according to the updated nested DRX cycle configuration, for example as described with reference to FIG. 5. UE 115 may monitor for signals during inner DRX cycle “on” durations which occur within outer DRX cycle “on” durations. UE 115 may further perform other operations such as transmissions and other processing as requested via received messages. For example, during an inner DRX cycle “on” duration, UE 115 may receive a DCI message which schedules subsequent PUSCH resources which UE 115 may use to transmit uplink messages to network unit 900. The scheduled transmissions may occur within, or outside of, the DRX cycle “on” durations. As discussed above with reference to FIGS. 6-7, DRX cycles may be skipped, or other parameters modified at least temporarily at the request of the UE.

FIG. 9 is a block diagram of an exemplary network unit 900 according to some aspects of the present disclosure. The network unit 900 may be a BS 105 as discussed in FIG. 1, or be made up of disaggregated units as described with reference to FIGS. 2-3. As shown, the network unit 900 may include a processor 902, a memory 904, an DRX module 908, a transceiver 910 including a modem subsystem 912 and a RF unit 914, and one or more antennas 916. These elements may be coupled with one another. The term “coupled” may refer to directly or indirectly coupled or connected to one or more intervening elements. For instance, these elements may be in direct or indirect communication with each other, for example via one or more buses.

The processor 902 may have various features as a specific-type processor. For example, these may include a CPU, a DSP, an ASIC, a controller, a FPGA device, another hardware device, a firmware device, or any combination thereof configured to perform the operations described herein. The processor 902 may also be implemented as a combination of computing devices, e.g., a combination of a DSP and a microprocessor, a plurality of microprocessors, one or more microprocessors in conjunction with a DSP core, or any other such configuration.

The memory 904 may include a cache memory (e.g., a cache memory of the processor 902), RAM, MRAM, ROM, PROM, EPROM, EEPROM, flash memory, a solid-state memory device, one or more hard disk drives, memristor-based arrays, other forms of volatile and non-volatile memory, or a combination of different types of memory. In some aspects, the memory 904 may include a non-transitory computer-readable medium. The memory 904 may store instructions 906. The instructions 906 may include instructions that, when executed by the processor 902, cause the processor 902 to perform operations described herein, for example, aspects of FIGS. 4-8 and 11-12. Instructions 906 may also be referred to as program code. The program code may be for causing a wireless communication device to perform these operations, for example by causing one or more processors (such as processor 902) to control or command the wireless communication device to do so. The terms “instructions” and “code” should be interpreted broadly to include any type of computer-readable statement(s). For example, the terms “instructions” and “code” may refer to one or more programs, routines, sub-routines, functions, procedures, etc. “Instructions” and “code” may include a single computer-readable statement or many computer-readable statements.

The DRX module 908 may be implemented via hardware, software, or combinations thereof. For example, the DRX module 908 may be implemented as a processor, circuit, and/or instructions 906 stored in the memory 904 and executed by the processor 902. In some examples, the DRX module 908 can be integrated within the modem subsystem 912. For example, the DRX module 908 can be implemented by a combination of software components (e.g., executed by a DSP or a general processor) and hardware components (e.g., logic gates and circuitry) within the modem subsystem 912. The DRX module 908 may communicate with one or more components of network unit 900 to implement various aspects of the present disclosure, for example, aspects of FIGS. 4-8 and 11-12.

The DRX module 908 may be configured to transmit data requirements to a UE 115 The requirements may include, for example, a number of PDSCH downlink transmissions, a number of PUSCH uplink transmissions, a number of measurements to perform, and/or other operations to be performed by the UE 115 during a DRX cycle. The requirements may be transmitted, for example, via PDSCH, via an RRC configuration, or a DCI message.

The DRX module 908 may be configured to receive recommended DRX parameters from the UE 115. In some aspects, data requirement information is not transmitted by DRX module 908, and instead of recommended DRX parameters, DRX module 908 receives UE capability information from the UE 115. UE capability information may include energy harvesting information and/or energy usage information as discussed with respect to FIG. 4.

The DRX module 908 may be configured to determine final DRX parameters based either on the recommended parameters or UE capability information received from UE 115. The final DRX parameters may include inner and outer DRX parameters as described with reference to FIG. 5 (i.e., T1_inner, T2_inner, T1_outer, and T2_outer). In some aspects, DRX module 908 may be configured to accept the parameters recommended by UE 115. In other aspects, DRX module 908 may be configured to consider additional information such as scheduling of communication with other UEs 115, network performance, additional power requirements, etc. Based on the determination, the final DRX parameters may be different than the recommended DRX parameters.

The DRX module 908 may be configured to configure the UE 115 using the final DRX parameters. The configuration may be transmitted, for example, via PDCCH or PUSCH, as a DCI message, and/or an RRC configuration.

The DRX module 908 may be configured to communicate with the UE 115 based on the DRX configuration, including transmitting messages to the UE 115 during inner DRX cycle “on” durations which occur within outer DRX cycle “on” durations.

The DRX module 908 may be configured to update DRX parameters as needed, on a schedule, or as requested by the UE 115. DRX module 908 may transmit updated requirements to the UE 115. DRX module 908 may receive updated recommended DRX parameters and/or updated UE capability information. Based on the received information, and potentially other network information, DRX module 908 may determine updated final DRX parameters. DRX module 908 may transmit the updated DRX parameters to the UE 115, and then communicate with the UE 115 based on the updated DRX configuration.

Finally, the DRX module 908 may be configured to respond to a request from the UE 115 to skip DRX cycles or otherwise change a DRX parameter at least temporarily. This may be done as described at action 616 of FIG. 6.

As shown, the transceiver 910 may include the modem subsystem 912 and the RF unit 914. The transceiver 910 can be configured to communicate bi-directionally with other devices, such as the UEs 115 and/or BS 105 and/or another core network element. The modem subsystem 912 may be configured to modulate and/or encode data according to a MCS, e.g., a LDPC coding scheme, a turbo coding scheme, a convolutional coding scheme, a digital beamforming scheme, etc. The RF unit 914 may be configured to process (e.g., perform analog to digital conversion or digital to analog conversion, etc.) modulated/encoded data (e.g., PDCCH DCI, PDSCH, etc.) from the modem subsystem 912 (on outbound transmissions) or of transmissions originating from another source such as a UE 115, and/or UE 1000. The RF unit 914 may be further configured to perform analog beamforming in conjunction with the digital beamforming. Although shown as integrated together in transceiver 910, the modem subsystem 912 and/or the RF unit 914 may be separate devices that are coupled together at the network unit 900 to enable the network unit 900 to communicate with other devices.

The RF unit 914 may provide the modulated and/or processed data, e.g. data packets (or, more generally, data messages that may contain one or more data packets and other information), to the antennas 916 for transmission to one or more other devices. The antennas 916 may further receive data messages transmitted from other devices and provide the received data messages for processing and/or demodulation at the transceiver 910. The transceiver 910 may provide the demodulated and decoded data (e.g., PUSCH, PUCCH, etc.) to the DRX module 908 for processing. The antennas 916 may include multiple antennas of similar or different designs in order to sustain multiple transmission links.

In an aspect, the network unit 900 can include multiple transceivers 910 implementing different RATs (e.g., NR and LTE). In an aspect, the network unit 900 can include a single transceiver 910 implementing multiple RATs (e.g., NR and LTE). In an aspect, the transceiver 910 can include various components, where different combinations of components can implement different RATs.

FIG. 10 is a block diagram of an exemplary UE 1000 according to some aspects of the present disclosure. The UE 1000 may be a UE 115 as discussed in FIGS. 1-8. As shown, the UE 1000 may include a processor 1002, a memory 1004, an DRX module 1008, a transceiver 1010 including a modem subsystem 1012 and a radio frequency (RF) unit 1014, and one or more antennas 1016. These elements may be coupled with one another. The term “coupled” may refer to directly or indirectly coupled or connected to one or more intervening elements. For instance, these elements may be in direct or indirect communication with each other, for example via one or more buses.

The processor 1002 may include a central processing unit (CPU), a digital signal processor (DSP), an application specific integrated circuit (ASIC), a controller, a field programmable gate array (FPGA) device, another hardware device, a firmware device, or any combination thereof configured to perform the operations described herein. The processor 1002 may also be implemented as a combination of computing devices, e.g., a combination of a DSP and a microprocessor, a plurality of microprocessors, one or more microprocessors in conjunction with a DSP core, or any other such configuration.

The memory 1004 may include a cache memory (e.g., a cache memory of the processor 1002), random access memory (RAM), magnetoresistive RAM (MRAM), read-only memory (ROM), programmable read-only memory (PROM), erasable programmable read only memory (EPROM), electrically erasable programmable read only memory (EEPROM), flash memory, solid state memory device, hard disk drives, other forms of volatile and non-volatile memory, or a combination of different types of memory. In an aspect, the memory 1004 includes a non-transitory computer-readable medium. The memory 1004 may store, or have recorded thereon, instructions 1006. The instructions 1006 may include instructions that, when executed by the processor 1002, cause the processor 1002 to perform the operations described herein with reference to a UE 115 in connection with aspects of the present disclosure, for example, aspects of FIGS. 4-8 and 11-12. Instructions 1006 may also be referred to as code, which may be interpreted broadly to include any type of computer-readable statement(s).

The DRX module 1008 may be implemented via hardware, software, or combinations thereof. For example, the DRX module 1008 may be implemented as a processor, circuit, and/or instructions 1006 stored in the memory 1004 and executed by the processor 1002. In some aspects, the DRX module 1008 can be integrated within the modem subsystem 1012. For example, the DRX module 1008 can be implemented by a combination of software components (e.g., executed by a DSP or a general processor) and hardware components (e.g., logic gates and circuitry) within the modem subsystem 1012. The DRX module 1008 may communicate with one or more components of UE 1000 to implement various aspects of the present disclosure, for example, aspects of FIGS. 4-8 and 11-12.

The DRX module 1008 may be configured to receive data requirements from a network unit 900. The requirements may include, for example, a number of PDSCH downlink transmissions, a number of PUSCH uplink transmissions, a number of measurements to perform, and/or other operations to be performed by the UE 1000 during a DRX cycle. The requirements may be received, for example, via PDSCH, via an RRC configuration, or a DCI message.

The DRX module 1008 may be configured to determine recommended DRX parameters. The determination may be based on the received requirements, in addition to information about UE 1000 such as energy harvesting capability, and energy usage information as discussed with respect to FIG. 4. For example, UE 1000 may have a known charging rate, a known total charge capacity, and may also have information about the amount of energy it takes the UE 1000 to perform different operations such as uplink, downlink, and radio resource management. DRX module 1008 may determine the amount of energy required to perform all of the operations indicated in the requirements received (i.e., a target energy level described in reference to FIG. 4). Given the needed energy, DRX module 1008 may then determine, based on the charging rate, etc., the amount of time (typically in increments of symbol periods) needed to charge. Based on these requirements and information, the DRX module 1008 may determine the recommended DRX parameters which allow sufficient charging time.

In some aspects, DRX module 1008 does not receive data requirements from a network unit 900, and does not transmit recommended DRX parameters. DRX module 1008 may transmit UE capability information such as charging rate, charging capacity, and/or energy requirements for different UE operations (e.g., as discussed with reference to FIG. 4) to the network unit 900.

The DRX module 1008 may be configured to transmit recommended DRX parameters to the network unit 900. DRX module 1008 may receive, in response, a configuration with final DRX parameters from the network unit 900. The configuration may be received, for example, via PDCCH or PUSCH, as a DCI message, and/or an RRC configuration.

The DRX module 1008 may be configured to communicate with the network unit 900 based on the DRX configuration, including monitoring for and receiving messages from the network unit 900 during inner DRX cycle “on” durations which occur within outer DRX cycle “on” durations.

The DRX module 1008 may be configured to request updated DRX parameters as needed, on a schedule, or as requested by the network unit 900. DRX module 1008 may transmit updated UE capability information, and/or updated recommended DRX parameters to the network unit 900. DRX module 1008 may receive updated final DRX parameters and communicate with the network unit 900 based on those updated parameters.

Finally, the DRX module 1008 may be configured to transmit a request to the network unit 900 to skip DRX cycles or otherwise change a DRX parameter at least temporarily. This may be done as the UE determines, for example, that insufficient energy has been harvested.

As shown, the transceiver 1010 may include the modem subsystem 1012 and the RF unit 1014. The transceiver 1010 can be configured to communicate bi-directionally with other devices, such as the BSs 105 and 500. The modem subsystem 1012 may be configured to modulate and/or encode the data from the memory 1004 and/or the DRX module 1008 according to a modulation and coding scheme (MCS), e.g., a low-density parity check (LDPC) coding scheme, a turbo coding scheme, a convolutional coding scheme, a digital beamforming scheme, etc. The RF unit 1014 may be configured to process (e.g., perform analog to digital conversion or digital to analog conversion, etc.) modulated/encoded data (e.g., PUSCH, PUCCH, etc.) or of transmissions originating from another source such as a UE 115, or a BS 105. The RF unit 1014 may be further configured to perform analog beamforming in conjunction with the digital beamforming. Although shown as integrated together in transceiver 1010, the modem subsystem 1012 and the RF unit 1014 may be separate devices that are coupled together at the UE 1000 to enable the UE 1000 to communicate with other devices.

The RF unit 1014 may provide the modulated and/or processed data, e.g., data packets (or, more generally, data messages that may contain one or more data packets and other information), to the antennas 1016 for transmission to one or more other devices. The antennas 1016 may further receive data messages transmitted from other devices. The antennas 1016 may provide the received data messages for processing and/or demodulation at the transceiver 1010. The transceiver 1010 may provide the demodulated and decoded data (e.g., PDCCH, PDSCH, etc.) to the DRX module 1008 for processing. The antennas 1016 may include multiple antennas of similar or different designs in order to sustain multiple transmission links. Antennas 1016 may include multiple antenna modules, each associated with a different antenna panel. Antenna panels may be used to transmit and/or receive using beamforming techniques.

In an aspect, the UE 1000 can include multiple transceivers 1010 implementing different RATs (e.g., NR and LTE). In an aspect, the UE 1000 can include a single transceiver 1010 implementing multiple RATs (e.g., NR and LTE). In an aspect, the transceiver 1010 can include various components, where different combinations of components can implement different RATs.

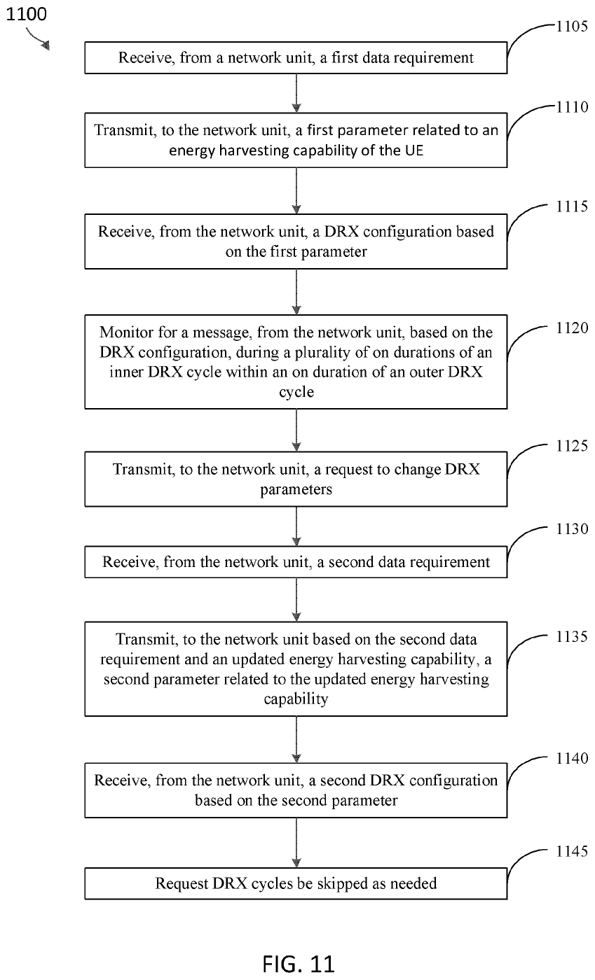

FIG. 11 is a flow diagram illustrating a wireless communication method 1100 according to some aspects of the present disclosure. Aspects of the method 1100 can be executed by a computing device (e.g., a processor, processing circuit, and/or other suitable component) of a wireless communication device or other suitable means for performing the blocks. In one aspect, a UE 115, or 1000, may perform the method 1100 utilizing components such as the processor 1002, the memory 1004, the DRX module 1008, the transceiver 1010, the modem 1012, and the one or more antennas 1016 shown in FIG. 10.

As illustrated, the method 1100 includes a number of enumerated blocks, but aspects of the method 1100 may include additional blocks before, after, and in between the enumerated blocks. In some aspects, one or more of the enumerated blocks may be omitted or performed in a different order.

At block 1105, a UE (e.g., UE 115, UE 1000, or other UE) receives, from a network unit (e.g., BS 105, network unit 900, CU 210, DU 230, and/or RU 240), a first data requirement. The first data requirement may include, for example, a number of PDSCH downlink transmissions, a number of PUSCH uplink transmissions, a number of measurements to perform, and/or other operations to be performed by the UE during a DRX cycle. The first data requirement may be received, for example, via PDSCH, via an RRC configuration, or a DCI message.

At block 1110, the UE transmits, to the network unit, a first parameter related to an energy harvesting capability of the UE. The first parameter may be recommended DRX parameters (i.e., T1_inner, T2_inner, T1_outer, and T2_outer) based on the first data requirement and energy harvesting capability. The first parameter may be energy harvesting capability information and/or energy usage information such as charging rate, charge capacity, a target energy level, and information about the energy usage of the UE in performing certain operations as described with reference to FIG. 4. The information may be indicated directly, and/or the UE may indicate a class of devices to which the UE belongs which is associated with known information. The class of devices may be explicitly signaled, or may be signaled as an index into a table which is available to the network unit 900.

At block 1115, the UE receives, from the network unit, a DRX configuration based on the first parameter. The DRX configuration parameters may include inner and outer DRX parameters as described with reference to FIG. 5 (i.e., T1_inner, T2_inner, T1_outer, and T2_outer). The UE may receive the configuration, for example, via PDCCH or PUSCH, as a DCI message, and/or an RRC configuration.

At block 1120, the UE monitors for a message, from the network unit, based on the DRX configuration, during a plurality of on durations of an inner DRX cycle within an on duration of an outer DRX cycle. For example, as described with reference to FIG. 5. The UE may monitor for signals during inner DRX cycle “on” durations which occur within outer DRX cycle “on” durations. The UE may further perform other operations such as transmissions and other processing as requested via received messages. For example, during an inner DRX cycle “on” duration, the UE may receive a DCI message which schedules subsequent PUSCH resources which the UE may use to transmit uplink messages to network unit. The scheduled transmissions may occur within, or outside of, the DRX cycle “on” durations.

At block 1125, the UE transmits, to the network unit, a request to change DRX parameters. This request may be made, for example, if the UE determines that an energy harvesting capability has changed, such as a changed charging rate based on current conditions.

At block 1130, the UE receives, from the network unit, a second data requirement. The second data requirement may include, for example, modified values from the first data requirement. The second data requirement may be received, for example, via PDSCH, via an RRC configuration, or a DCI message. Updated requirements may be transmitted any time there is a change, or may be re-transmitted periodically by the network unit.

At block 1135, the UE transmits, to the network unit based on the second data requirement and an updated energy harvesting capability, a second parameter related to the updated energy harvesting capability. The second parameter may be similar to the first parameter as described above, but having updated values based on the updated information.

At block 1140, the UE receives, from the network unit, a second DRX configuration based on the second parameter. The UE may then communicate with the network unit according to the updated second DRX configuration.

At block 1145, the UE may request certain DRX cycles be skipped, or that some parameter bee modified at least temporarily. The UE may transmit, for example during a first on duration of the inner DRX cycle within the on duration of the outer DRX cycle, a request to skip one or more DRX cycles. In some aspects, The UE requests to skip an indicated number of uplink transmissions per inner DRX cycle. In other aspects, The UE requests to skip an indicated number of downlink receptions per inner DRX cycle. In other aspects, The UE requests to skip an entire outer DRX cycle on duration. In yet further aspects, The UE requests to update one or more outer DRX cycle on time durations. Finally, The UE may request any combination of the above.

The UE may request skipping DRX cycles or modification of parameters such as outer DRX cycle on time duration in response to not charging sufficient energy between DRX “on” durations. Rather than attempt to communicate at the scheduled times according to the DRX parameters, the UE may request these changes to dynamically respond to changing circumstances.

In response to a request, network unit 900 may refrain from transmitting messages during the scheduled DRX “on” duration, and wait for the next available DRX “on” duration as requested by the UE.

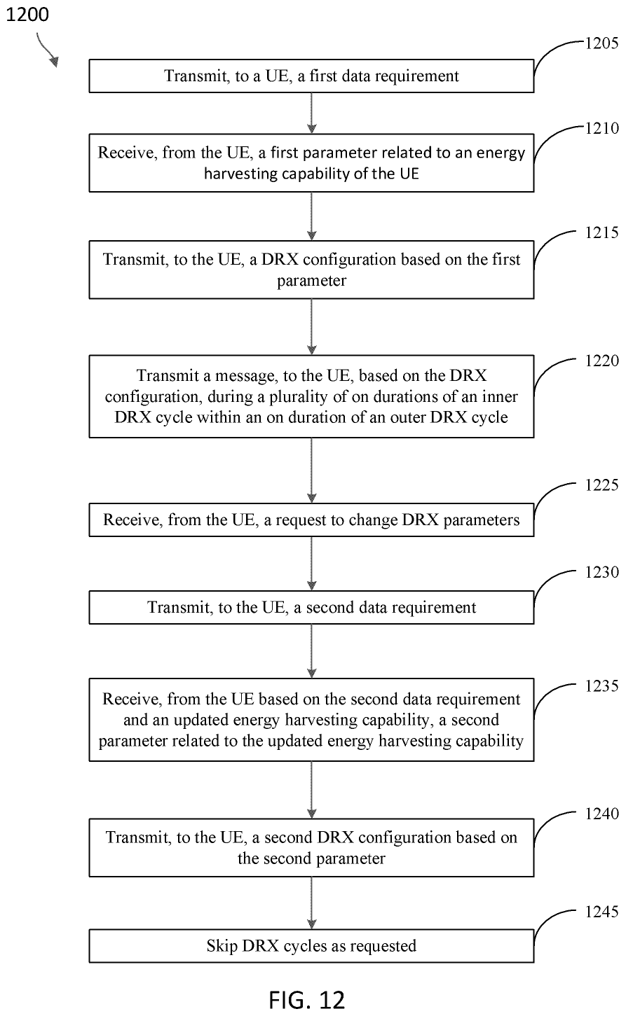

FIG. 12 is a flow diagram illustrating a wireless communication method 1200 according to some aspects of the present disclosure. Aspects of the method 1200 can be executed by a computing device (e.g., a processor, processing circuit, and/or other suitable component) of a wireless communication device or other suitable means for performing the blocks. In one aspect, a BS 105, a CU 210 and/or DU 230, or network unit 900, may perform the method 1200 utilizing components such as the processor 902, the memory 904, the DRX module 908, the transceiver 910, the modem 912, and the one or more antennas 916 shown in FIG. 9.

As illustrated, the method 1200 includes a number of enumerated blocks, but aspects of the method 1200 may include additional blocks before, after, and in between the enumerated blocks. In some aspects, one or more of the enumerated blocks may be omitted or performed in a different order.

At block 1205, a network unit (e.g., BS 105, network unit 900, CU 210, DU 230, and/or RU 240) transmits, to a UE (e.g., UE 115, UE 1000, or other UE), a first data requirement. The first data requirement may include, for example, a number of PDSCH downlink transmissions, a number of PUSCH uplink transmissions, a number of measurements to perform, and/or other operations to be performed by the UE during a DRX cycle. The first data requirement may be transmitted, for example, via PDSCH, via an RRC configuration, or a DCI message.

At block 1210, the network unit receives, from the UE, a first parameter related to an energy harvesting capability of the UE. The first parameter may be recommended DRX parameters (i.e., T1_inner, T2_inner, T1_outer, and T2_outer) based on the first data requirement and energy harvesting capability. The first parameter may be energy harvesting capability information and/or energy usage information such as charging rate, charge capacity, a target energy level, and information about the energy usage of the UE in performing certain operations as described with respect to FIG. 4. The information may be indicated directly, and/or the UE may indicate a class of devices to which the UE belongs which is associated with known information. The class of devices may be explicitly signaled, or may be signaled as an index into a table which is available to the network unit 900.

At block 1215, the network unit transmits, to the UE, a DRX configuration based on the first parameter. The DRX configuration parameters may include inner and outer DRX parameters as described with reference to FIG. 5 (i.e., T1_inner, T2_inner, T1_outer, and T2_outer). The network unit may transmit the configuration, for example, via PDCCH or PUSCH, as a DCI message, and/or an RRC configuration.

At block 1220, the network unit transmits a message, to the UE, based on the DRX configuration, during a plurality of on durations of an inner DRX cycle within an on duration of an outer DRX cycle. For example, as described with reference to FIG. 5. The network unit may transmit signals to the UE during inner DRX cycle “on” durations which occur within outer DRX cycle “on” durations. The network unit may further direct the UE in a transmitted message to perform other operations such as UE transmissions and other processing. For example, during an inner DRX cycle “on” duration, the network unit may transmit a DCI message which schedules subsequent PUSCH resources which the UE may use to transmit uplink messages to network unit. The scheduled PUSCH communication may occur within, or outside of, the DRX cycle “on” durations.

At block 1225, the network unit receives, from the UE, a request to change DRX parameters. This request may be made, for example, if the UE determines that an energy harvesting capability has changed, such as a changed charging rate based on current conditions.

At block 1230, the network unit transmits, to the UE, a second data requirement. The second data requirement may include, for example, modified values from the first data requirement. The second data requirement may be transmitted by the network unit, for example, via PDSCH, via an RRC configuration, or a DCI message. Updated requirements may be transmitted any time there is a change, or may be re-transmitted periodically by the network unit.

At block 1235, the network unit receives, from the UE based on the second data requirement and an updated energy harvesting capability, a second parameter related to the updated energy harvesting capability. The second parameter may be similar to the first parameter as described above, but having updated values based on the updated information.

At block 1240, the network unit transmits, to the UE, a second DRX configuration based on the second parameter. The network unit may then communicate with the UE according to the updated second DRX configuration.

At block 1245, the network unit may receive a request from the UE that certain DRX cycles be skipped, or that some parameter bee modified at least temporarily. The network unit may receive, for example during a first on duration of the inner DRX cycle within the on duration of the outer DRX cycle, a request to skip one or more DRX cycles. In some aspects, The UE requests to skip an indicated number of uplink transmissions per inner DRX cycle. In other aspects, The UE requests to skip an indicated number of downlink receptions per inner DRX cycle. In other aspects, The UE requests to skip an entire outer DRX cycle on duration. In yet further aspects, The UE requests to update one or more outer DRX cycle on time durations. Finally, The UE may request any combination of the above.

In response to a request, network unit may refrain from transmitting messages during the scheduled DRX “on” duration, and wait for the next available DRX “on” duration as requested by the UE.

Further aspects of the present disclosure include the following:

Aspect 1. A method of wireless communication, comprising:
receiving, by an energy harvesting user equipment (UE) from a network unit, a data requirement;
transmitting, by the UE to the network unit, a first parameter related to an energy harvesting capability of the UE;
receiving, by the UE from the network unit, a DRX configuration based on the first parameter, the DRX configuration including:
   an outer DRX cycle duration;
   an outer DRX cycle on time duration;
   an inner DRX cycle duration; and
   an inner DRX cycle on time duration; and
monitoring for a message from the network unit, based on the DRX configuration, during a plurality of on durations of an inner DRX cycle within an on duration of an outer DRX cycle.

Aspect 2. The method of aspect 1, wherein the first parameter is at least one of:
a set of suggested DRX parameters;
an indication of a class of devices to which the UE belongs;
a charging rate; or
an amount of energy consumed by the UE during an operation.

Aspect 3. The method of any of aspects 1-2, wherein the energy harvesting capability includes at least one of:
a charging rate;
a charging capacity; or
an amount of energy consumed by the UE during an operation.

Aspect 4. The method of any of aspects 1-3, wherein the data requirement includes at least one of:
an amount of downlink messages and an amount of uplink messages; or a target energy level.

Aspect 5. The method of any of aspects 1-4, further comprising:
receiving, by the UE from the network unit, a second data requirement;
transmitting, by the UE to the network unit based on the second data requirement and an updated energy harvesting capability, a second parameter related to the updated energy harvesting capability; and
receiving, by the UE from the network unit, a second DRX configuration based on the second parameter.

Aspect 6. The method of aspect 5, further comprising:
transmitting, by the UE to the network unit, a request to change DRX parameters,
wherein the receiving the second data requirement is based on the request to change DRX parameters.

Aspect 7. The method of any of aspects 1-6, further comprising:
maintaining, by the UE, a radio resource control (RRC) state across both the inner DRX cycle and the outer DRX cycle.

Aspect 8. The method of any of aspects 1-7, further comprising:
transmitting, by the UE during a first on duration of the inner DRX cycle within the on duration of the outer DRX cycle, a request to perform at least one of:
   skipping an indicated number of uplink transmissions per inner DRX cycle,
   skipping an indicated number of downlink receptions per inner DRX cycle,
   skipping an entire outer DRX cycle on duration, or
   updating one or more outer DRX cycle on time durations.

Aspect 9. A method of wireless communication, comprising:
transmitting, by a network unit to an energy harvesting user equipment (UE), a data requirement;
receiving, by the network unit from the UE, a first parameter related to an energy harvesting capability of the UE;
transmitting, by the network unit to the UE, a DRX configuration based on the first parameter, the DRX configuration including:
   an outer DRX cycle duration;
   an outer DRX cycle on time duration;
   an inner DRX cycle duration; and
   an inner DRX cycle on time duration; and
transmitting a message from the network unit, based on the DRX configuration, during a plurality of on durations of an inner DRX cycle within an on duration of an outer DRX cycle.

Aspect 10. The method of aspect 9, wherein the first parameter is at least one of:
a set of suggested DRX parameters;
an indication of a class of devices to which the UE belongs;
a charging rate; or
an amount of energy consumed by the UE during an operation.

Aspect 11. The method of any of aspects 9-10, wherein the energy harvesting capability includes at least one of:
a charging rate;
a charging capacity; or
an amount of energy consumed by the UE during an operation.

Aspect 12. The method of any of aspects 9-11, wherein the data requirement includes at least one of:
an amount of downlink messages and an amount of uplink messages; or a target energy level.

Aspect 13. The method of any of aspects 9-12, further comprising:
transmitting, by the network unit to the UE, a second data requirement;
receiving, by the network unit from the UE based on the second data requirement and an updated energy harvesting capability, a second parameter related to the updated energy harvesting capability; and
transmitting, by the network unit to the UE, a second DRX configuration based on the second parameter.

Aspect 14. The method of aspect 13, further comprising:
receiving, by the network unit from the UE, a request to change DRX parameters,
wherein the transmitting the second data requirement is based on the request to change DRX parameters.

Aspect 15. The method of any of aspects 9-14, further comprising:
receiving, by the network unit during a first on duration of the inner DRX cycle within the on duration of the outer DRX cycle, a request to perform at least one of:
   skipping an indicated number of uplink transmissions per inner DRX cycle,
   skipping an indicated number of downlink receptions per inner DRX cycle,
   skipping an entire outer DRX cycle on duration, or
   updating one or more outer DRX cycle on time durations.

Aspect 16. An energy harvesting user equipment (UE) comprising:
a transceiver configured to:
   receive, from a network unit, a data requirement;
   transmit, to the network unit, a first parameter related to an energy harvesting capability of the UE;
   receive, from the network unit, a DRX configuration based on the first parameter, the DRX configuration including:
      an outer DRX cycle duration;
      an outer DRX cycle on time duration;
      an inner DRX cycle duration; and
      an inner DRX cycle on time duration; and
a processor configured to:
   monitor for a message, from the network unit, based on the DRX configuration, during a plurality of on durations of an inner DRX cycle within an on duration of an outer DRX cycle.

Aspect 17. The UE of aspect 16, wherein the first parameter is at least one of:
a set of suggested DRX parameters;
an indication of a class of devices to which the UE belongs;
a charging rate; or
an amount of energy consumed by the UE during an operation.

Aspect 18. The UE of any of aspects 16-17, wherein the energy harvesting capability includes at least one of:
a charging rate;
a charging capacity; or
an amount of energy consumed by the UE during an operation.

Aspect 19. The UE of any of aspects 16-18, wherein the data requirement includes at least one of:
an amount of downlink messages and an amount of uplink messages; or
a target energy level.

Aspect 20. The UE of any of aspects 16-19, wherein the transceiver is further configured to:
receive, from the network unit, a second data requirement;
transmit, to the network unit based on the second data requirement and an updated energy harvesting capability, a second parameter related to the updated energy harvesting capability; and
receive, from the network unit, a second DRX configuration based on the second parameter.

Aspect 21. The UE of aspect 20, wherein the transceiver is further configured to:
transmit, to the network unit, a request to change DRX parameters,
wherein the receiving the second data requirement is based on the request to change DRX parameters.

Aspect 22. The UE of any of aspects 16-21, wherein the processor is further configured to:
maintain, by the UE, a radio resource control (RRC) state across both the inner DRX cycle and the outer DRX cycle.

Aspect 23. The UE of any of aspects 16-22, wherein the transceiver is further configured to:
transmit, during a first on duration of the inner DRX cycle within the on duration of the outer DRX cycle, a request to perform at least one of:
   skipping an indicated number of uplink transmissions per inner DRX cycle,
   skipping an indicated number of downlink receptions per inner DRX cycle,
   skipping an entire outer DRX cycle on duration, or
   updating one or more outer DRX cycle on time durations.

Aspect 24. A network unit, comprising:
a transceiver configured to:
   transmit, to an energy harvesting user equipment (UE), a data requirement;
   receive, from the UE, a first parameter related to an energy harvesting capability of the UE;
   transmit, to the UE, a DRX configuration based on the first parameter, the DRX configuration including:
      an outer DRX cycle duration;
      an outer DRX cycle on time duration;
      an inner DRX cycle duration; and
      an inner DRX cycle on time duration; and
   transmit a message, based on the DRX configuration, during a plurality of on durations of an inner DRX cycle within an on duration of an outer DRX cycle.

Aspect 25. The network unit of aspect 24, wherein the first parameter is at least one of:
a set of suggested DRX parameters;
an indication of a class of devices to which the UE belongs;
a charging rate; or
an amount of energy consumed by the UE during an operation.

Aspect 26. The network unit of any of aspects 24-25, wherein the energy harvesting capability includes at least one of:
a charging rate;
a charging capacity; or
an amount of energy consumed by the UE during an operation.

Aspect 27. The network unit of any of aspects 24-26, wherein the data requirement includes at least one of:
an amount of downlink messages and an amount of uplink messages; or a target energy level.

Aspect 28. The network unit of any of aspects 24-27, wherein the transceiver is further configured to:
transmit, to the UE, a second data requirement;
receive, from the UE based on the second data requirement and an updated energy harvesting capability, a second parameter related to the updated energy harvesting capability; and transmit, to the UE, a second DRX configuration based on the second parameter.

Aspect 29. The network unit of aspect 28, wherein the transceiver is further configured to:
receive, from the UE, a request to change DRX parameters,
wherein the transmitting the second data requirement is based on the request to change DRX parameters.

Aspect 30. The network unit of any of aspects 24-29, wherein the transceiver is further configured to:
receive, during a first on duration of the inner DRX cycle within the on duration of the outer DRX cycle, a request to perform at least one of:
   skipping an indicated number of uplink transmissions per inner DRX cycle,
   skipping an indicated number of downlink receptions per inner DRX cycle,
   skipping an entire outer DRX cycle on duration, or
   updating one or more outer DRX cycle on time durations.

Aspect 31. The method of aspect 2, wherein the amount of energy consumed by the UE during an operation is an amount of energy required by the UE to perform at least one of:
reference signal processing;
uplink data processing;
downlink data processing;
physical downlink control channel (PDCCH) processing;
physical uplink control channel (PUCCH) processing; or
detecting no downlink control information (DCI).

Aspect 32. The method of aspect 31, wherein the amount of energy consumed by the UE during an operation is stored in the first parameter in reference to a resource element (RE) or resource block (RB).

Aspect 33. The method of aspect 1, wherein the first parameter is transmitted in at least one of:
a synchronization signal block (SSB);
a system information block (SIB); or
a random access message.

Information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The various illustrative blocks and modules described in connection with the disclosure herein may be implemented or performed with a general-purpose processor, a DSP, an ASIC, an FPGA or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described above can be implemented using software executed by a processor, hardware, firmware, hardwiring, or combinations of any of these. Features implementing functions may also be physically located at various positions, including being distributed such that portions of functions are implemented at different physical locations. Also, as used herein, including in the claims, “or” as used in a list of items (for example, a list of items prefaced by a phrase such as “at least one of” or “one or more of”) indicates an inclusive list such that, for example, a list of [at least one of A, B, or C] means A or B or C or AB or AC or BC or ABC (i.e., A and B and C).

As those of some skill in this art will by now appreciate and depending on the particular application at hand, many modifications, substitutions and variations can be made in and to the materials, apparatus, configurations and methods of use of the devices of the present disclosure without departing from the spirit and scope thereof. In light of this, the scope of the present disclosure should not be limited to that of the particular aspects illustrated and described herein, as they are merely by way of some examples thereof, but rather, should be fully commensurate with that of the claims appended hereafter and their functional equivalents.

1. A method of wireless communication, comprising:
receiving, by an energy harvesting user equipment (UE) from a network unit, a data requirement;
transmitting, by the UE to the network unit, a first parameter related to an energy harvesting capability of the UE;
receiving, by the UE from the network unit, a DRX configuration based on the first parameter, the DRX configuration including:
an outer DRX cycle duration;
an outer DRX cycle on time duration;
an inner DRX cycle duration; and
an inner DRX cycle on time duration; and
monitoring for a message from the network unit, based on the DRX configuration, during a plurality of on durations of an inner DRX cycle within an on duration of an outer DRX cycle.

2. The method of claim 1, wherein the first parameter is at least one of:
a set of suggested DRX parameters;
an indication of a class of devices to which the UE belongs;
a charging rate; or
an amount of energy consumed by the UE during an operation.

3. The method of claim 1, wherein the energy harvesting capability includes at least one of:
a charging rate;
a charging capacity; or
an amount of energy consumed by the UE during an operation.

4. The method of claim 1, wherein the data requirement includes at least one of:
an amount of downlink messages and an amount of uplink messages; or
a target energy level.

5. The method of claim 1, further comprising:
receiving, by the UE from the network unit, a second data requirement;
transmitting, by the UE to the network unit based on the second data requirement and an updated energy harvesting capability, a second parameter related to the updated energy harvesting capability; and
receiving, by the UE from the network unit, a second DRX configuration based on the second parameter.

6-15. (canceled)

16. An energy harvesting user equipment (UE) comprising:
a transceiver configured to:
receive, from a network unit, a data requirement;
transmit, to the network unit, a first parameter related to an energy harvesting capability of the UE;
receive, from the network unit, a DRX configuration based on the first parameter, the DRX configuration including:
an outer DRX cycle duration;
an outer DRX cycle on time duration;
an inner DRX cycle duration; and
an inner DRX cycle on time duration; and
one or more processors individually or collectively configured to cause the UE to:
monitor for a message, from the network unit, based on the DRX configuration, during a plurality of on durations of an inner DRX cycle within an on duration of an outer DRX cycle.

17. The UE of claim 16, wherein the first parameter is at least one of:
a set of suggested DRX parameters;
an indication of a class of devices to which the UE belongs;
a charging rate; or
an amount of energy consumed by the UE during an operation.

18. The UE of claim 16, wherein the energy harvesting capability includes at least one of:
a charging rate;
a charging capacity; or
an amount of energy consumed by the UE during an operation.

19. The UE of claim 16, wherein the data requirement includes at least one of:
an amount of downlink messages and an amount of uplink messages; or
a target energy level.

20. The UE of claim 16, wherein the transceiver is further configured to:
receive, from the network unit, a second data requirement;
transmit, to the network unit based on the second data requirement and an updated energy harvesting capability, a second parameter related to the updated energy harvesting capability; and
receive, from the network unit, a second DRX configuration based on the second parameter.

21. The UE of claim 20, wherein the transceiver is further configured to:
transmit, to the network unit, a request to change DRX parameters,
wherein the receiving the second data requirement is based on the request to change DRX parameters.

22. The UE of claim 16, wherein the one or more processors are individually or collectively configured to cause the UE to:
maintain, by the UE, a radio resource control (RRC) state across both the inner DRX cycle and the outer DRX cycle.

23. The UE of claim 16, wherein the transceiver is further configured to:
transmit, during a first on duration of the inner DRX cycle within the on duration of the outer DRX cycle, a request to perform at least one of:
skipping an indicated number of uplink transmissions per inner DRX cycle,
skipping an indicated number of downlink receptions per inner DRX cycle,
skipping an entire outer DRX cycle on duration, or
updating one or more outer DRX cycle on time durations.

24. A network unit, comprising:
a transceiver configured to:
transmit, to an energy harvesting user equipment (UE), a data requirement;
receive, from the UE, a first parameter related to an energy harvesting capability of the UE;
transmit, to the UE, a DRX configuration based on the first parameter, the DRX configuration including:
an outer DRX cycle duration;
an outer DRX cycle on time duration;
an inner DRX cycle duration; and
an inner DRX cycle on time duration; and
transmit a message, based on the DRX configuration, during a plurality of on durations of an inner DRX cycle within an on duration of an outer DRX cycle.

25. The network unit of claim 24, wherein the first parameter is at least one of:
a set of suggested DRX parameters;
an indication of a class of devices to which the UE belongs;
a charging rate; or
an amount of energy consumed by the UE during an operation.

26. The network unit of claim 24, wherein the energy harvesting capability includes at least one of:
a charging rate;
a charging capacity; or
an amount of energy consumed by the UE during an operation.

27. The network unit of claim 24, wherein the data requirement includes at least one of:
an amount of downlink messages and an amount of uplink messages; or
a target energy level.

28. The network unit of claim 24, wherein the transceiver is further configured to:
transmit, to the UE, a second data requirement;
receive, from the UE based on the second data requirement and an updated energy harvesting capability, a second parameter related to the updated energy harvesting capability; and
transmit, to the UE, a second DRX configuration based on the second parameter.

29. The network unit of claim 28, wherein the transceiver is further configured to:
receive, from the UE, a request to change DRX parameters,
wherein the transmitting the second data requirement is based on the request to change DRX parameters.

30. The network unit of claim 24, wherein the transceiver is further configured to:
receive, during a first on duration of the inner DRX cycle within the on duration of the outer DRX cycle, a request to perform at least one of:
skipping an indicated number of uplink transmissions per inner DRX cycle,
skipping an indicated number of downlink receptions per inner DRX cycle,
skipping an entire outer DRX cycle on duration, or
updating one or more outer DRX cycle on time durations.
